(19) United States
(12) Patent Application Publication
(10) Pub. No.: US 2007/0229350 A1
(43) Pub. Date: Oct. 4, 2007

(54) Apparatus and Method for Providing Location Information on Individuals and Objects using Tracking Devices

(76) Inventors: Joseph F. Scalisi, Yorba Linda, CA (US); David M. Morse, Laguna Hills, CA (US); Desiree Mejia, Redondo Beach, CA (US); Roger B. Anderson, Arcadia, CA (US); Michael L. Beydler, Irvine, CA (US)

Correspondence Address: Law Office of Robert E. Kasody, Professional Corp., Suite 500, 6601 Center Drive West, Los Angeles, CA, 90045, US

(21) Appl. No.: 11/753,979

(22) Filed: May 25, 2007

Related U.S. Application Data
(63) Continuation-in-part of application No. 11/491,370, filed on Jul. 21, 2006.
(63) Continuation-in-part of application No. 11/048,395, filed on Feb. 1, 2005, now abandoned.

(51) Int. Cl. G01S 5/00

(52) U.S. Cl. 342/350

(57) ABSTRACT

A system for monitoring objects and individuals. The system includes a first tracking device and a monitoring station to track location information. A user interface provides to remotely access the monitoring station. The user interface includes a graphical rendering to select a series of keystrokes. The graphical rendering prevents unauthorized recording of the series of keystrokes. A first request signal communicated obtains location coordinates of a first tracking device. The first tracking device transmits a first reply signal that comprises a first identification code. A second tracking device receives the first reply signal, compares the first identification code to a stored identification code and communicates to the monitoring station a second reply signal that comprises the location coordinates of the first tracking device.

### PRIORITY APPLICATIONS

This application is a continuation-in-part (CIP) of and claims priority to U.S. patent application Ser. No. 11/491,370 filed on Jul. 21, 2006, entitled “Apparatus and Method for Locating Individuals and objects using tracking devices” which is incorporated herein by reference in its entirety. Furthermore, this application is a continuation-in-part (CIP) of and claims priority to U.S. patent application Ser. No. 11/048,395 filed on Feb. 1, 2005, entitled “System for Locating Individuals and Objects” which is incorporated herein by reference in its entirety.

### BACKGROUND OF THE INVENTION

1. Field of the Invention

The invention relates generally to the field of communications systems that provide location information. More particularly, the present invention relates in one embodiment to a system for monitoring location information of a tracking unit associated with an individual or object that uses wireless data transfer and/or wireless location and tracking systems and wireless communication system (WCS).

2. Description of Related Technology

In conventional communication systems, location information of individuals may be monitored. For instance, location information such as positional coordinates may be tracked or monitored for a variety of individuals, such as children, Alzheimer's syndrome patients, or mentally ill persons. Furthermore, location information for animals, such as cats and dogs, may be tracked using these conventional systems to locate a lost or stolen animal. In other conventional communication systems, scientists, such as zoologists, track, for example, wild animals to study and collect data related to their mating and/or nocturnal behavioral patterns.

In addition, objects are also tracked or located that use these systems. For example, merchants choose to track the location of goods as part of an inventory function and/or an anti-theft mode. In another example, police often use location-tracking systems to facilitate recovery of stolen automobiles, such as the LoJack™ vehicle recovery system offered by the LoJack Corporation of Westwood, Mass., in the United States. Automobile rental agencies often track a location of automobiles that customers rent to ensure their automobile is maintained within a contracted rental use boundary. Other location systems provided in select automobiles assist a driver navigating to a desired destination, such as the OnStar™ system offered by the OnStar Corporation of Detroit, Mich., in the United States.

Global Positioning System (GPS) technology may be incorporated in these conventional communication systems. GPS technology determines positional information of a GPS receiver based on measuring signal transfer times between satellites having known positions and the GPS receiver. The signal transfer time of a signal is proportional to a distance of a respective satellite from the GPS receiver. Consequently, the distance between the satellite and the GPS receiver can be converted, utilizing signal propagation velocity, into a respective signal transfer time. The positional information of the GPS receiver is calculated based on distance calculations from at least four satellites.

As such, GPS technology provides outdoor, line-of-sight communication between a GPS receiver and a centralized station within areas that are unobstructed by fabricated structures and natural features. Fabricated structures may include multi-story buildings, bridges, dams, and the like. Natural features include mountains, hills, valleys, canyons, cliffs, and the like. Exemplary products, such as Wherifone™ and Guardian Lion™, use GPS technology to track individuals and/or objects from a centralized monitoring station.

Conventional centralized monitoring station in many instances may use a map that may be two dimensional, or even a three-dimensional, topological map that depicts landscaping, marine, or other environments. The map typically displays representative icons of individuals and/or objects being tracked. In one example, a mobile device may display the three-dimensional map, including primary regions and sub-regions that are pre-programmed to create a series of overlay maps for viewing on a computer display. In yet another example, map information of a first and second user terminal is synthesized; a map is chosen based on the map information from the database; and the map information is displayed on at least one of the first user and the second user terminal. In another GPS conventional communication example, GPS positioning information is transmitted from a GPS unit and between peripheral devices, such as between a camera and a Palm Pilot, through a local wireless communication unit or interface.

In yet another example, a location of small wireless devices on roaming objects is determined by achieving ad-hoc short range wireless connectivity between the wireless devices and communication devices such as Bluetooth enabled mobile phones that pass by, where the communication devices can be located by other means, such as GPS or network-based technologies. Other examples include a location-determining device monitors at least one automatic sensor associated with a subject. Still other alert systems include upon a child feeling endangered, a panic button is pressed to send a panic signal to tell others their location. Still another conventional system depicts a personal security device that includes a manager initiating transmission of a signal to the monitoring network when a sensor senses that the transmitter has been removed from a user. Other conventional tracking and location systems include a central monitoring station utilizing software agents to analyze information received from remote tags, and to determine an appropriate action to take with respect to that information.

GPS systems generally representative of the above apparatuses include, e.g., those described in U.S. Pat. No. 7,064,711 to Strickland et al. entitled “Method for Iterative Determination of Distance between Receiving Station and Transmitting Station and Also Calculating Unit and Computer Software Product” issued Jun. 20, 2006. In other examples, U.S. Pat. No. 7,065,244 to Akimov issued on Jun. 20, 2006 and entitled “Method for Mapping a Three Dimensional Area”, and U.S. Pat. No. 7,065,370 to Ogaki et al. entitled “Positioning Information Transmitting Device and Positioning Information Transmitting/Receiving System” issued on Jun. 20, 2006. Other representative prior art patents include U.S. Pat. No. 7,065,348 to Aoki entitled “Communication System for Providing Information on Position of Communication Party” issued on Jun. 20, 2006, and U.S. Pat. No. 7,155,238 to Katz entitled “Wireless Location Determining Device” issued on Dec. 26, 2006. U.S. Pat. No. 7,049,957 to Watson entitled “Local Area Positioning System” issued on May 23, 2006 and U.S. Pat. No. 6,674,368 to Hawkins et al. entitled “Automated Tracking System” issued on Jan. 6, 2004, illustrate other tracking apparatus and hardware for the above described GPS systems. Furthermore, other representative prior art patents demonstrating additional elements of GPS systems include U.S. Pat. No. 6,998,995 to Nakajima entitled “Elevator Remote Monitoring Apparatus” issued on Feb. 14, 2006; and U.S. Pat. No. 7,038,590 to Hoffman et al. entitled “Personal Security and Tracking System” issued on May 2, 2006. U.S. Pat. No. 7,088,252 to Weekes entitled “Systems and Apparatus for Personal Security” issued on Aug. 8, 2006; and US 2006/0232449 to Gonzalez entitled “Child Alert System” published on Oct. 19, 2006. Finally, US 2002/0067256 to Kail IV entitled “Reprogrammable Remote Sensor Monitoring System” published on Jun. 6, 2002; and U.S. Pat. No. 7,149,189 to Huntington et al. entitled “Network Data Retrieval and Filter Systems and Methods” issued on Dec. 12, 2006, are patents illustrating further aspects of conventional GPS systems.

In summary, the prior art provides a user limited flexibility to adjust a controlled monitoring area about an object. In addition, the prior art provides limited flexibility for a user choosing and creating custom maps for viewing and locating objects. Furthermore, the prior art has limited ability calculating positional data of objects when GPS signaling is unavailable.

Thus, what is needed are apparatus and methods for wireless data transfer and/or wireless location and tracking systems that provide additional advantages over conventional systems. These advantages would include, inter alia, calculating positional data and location coordinates of tracking devices when GPS signaling is unavailable, providing graphical displays for subscribers which aid monitoring and tracking objects and/or individuals, and/or providing security measures when monitoring tracking devices to prevent unauthorized detection and spying on individuals.

### SUMMARY OF THE INVENTION

In a first aspect of the present invention, a device for tracking is disclosed. The system includes a first tracking device and a monitoring station to track location information of the first tracking device. A user interface is provided to remotely access the monitoring station. In one embodiment, the user interface includes a graphical rendering of a keypad and a tool useful to select a series of keystrokes. Upon successful completion of a login process associated with the user interface, the first tracking device receives a first request signal to obtain its location coordinates. The first tracking device transmits a first reply signal including a first identification code. A second tracking device receives the first reply signal, and, compares the first identification code to a stored identification code, and communicates to the monitoring station a second reply signal. In one embodiment, the second reply signal comprises the location coordinates of the first tracking device.

In a second aspect of the invention, a system is disclosed comprising a first and a second tracking device. The system includes a first tracking device configured to receive a first request signal in response to successful completion of a secure login process on a keyboard rendering on a remote user terminal, and to transmit a first reply signal that comprise a first identification code. In one embodiment, entries on the keyboard rendering on the remote user terminal are substantially untraceable by keystroke recording software. In addition, a second tracking device is configured to receive the first reply signal, compare the first identification code to a stored identification code, determine location coordinates of the first tracking device, and communicate a second reply signal that comprises the location coordinates to a monitoring station.

In a third aspect of the present invention, a method is disclosed for locating an individual or an object. The method includes the steps of entering on a non-secure user webpage a user's identification code and a user's password to access an location coordinate Internet database in a remote monitoring station that is securely selectively shared among authorized users. In one embodiment, during an entry process, the user's identification code and the user's password are substantially prevented being recorded by unauthorized devices or software. The method may include the steps upon successful entry of the user's identification code and the user's password, activating the tracking device associated with the user's identification code, and receiving a signal communicated between the remote monitoring station and the tracking device. In yet another embodiment, the method may include the steps of recognizing the user's identification code as a location request pertaining to the tracking device, and requesting positioning coordinates. In yet another embodiment, the method may include the steps of formatting a response to the location request including the positioning coordinates, transmitting the response to a server; and rendering the tracking device location within a map that contains a user-defined arbitrary shaped safe zone.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIGS. 1A and 1B are graphical representations of a positioning and tracking system for defining an area (e.g., arbitrary shaped safe zone) in accordance with an embodiment of the present invention.

FIGS. 2A, 2B, 2C and 2D are graphical representations of a positioning and tracking system for a second tracking device utilized to find location coordinates of a first tracking device in accordance with an embodiment of the present invention.

FIG. 3 is a graphical representation of a positioning and tracking system utilizing a wireless communication system to determine location coordinates for the first tracking device in accordance with an embodiment of the present invention.

FIG. 4 is a graphical representation of a positioning and tracking system 700 for locating a first tracking device 402 using other user's tracking devices.

FIG. 5 is a functional block diagram of the first tracking device in accordance with an embodiment of the present invention.

FIGS. 6A, 6B are logical flow diagrams illustrating one exemplary embodiment of a method for locating an individual or an object in accordance with an embodiment of the present invention.

FIGS. 7A, 7B are logical flow diagrams illustrating a method for locating an individual or an object in accordance with an embodiment of the present invention.

FIG. 8 is a graphical representation of a user interface in accordance with an embodiment of the present invention.

FIG. 9 is a table depicting device modes in accordance with an embodiment of the present invention.

FIGS. 10A-10C are tables of messages communicated in accordance with an embodiment of the present invention.

FIGS. 11A-11J are tables illustrating commands for a web service in accordance with an embodiment of the present invention.

FIG. 12 is a graphical representation of a gatekeeper interface in accordance with an embodiment of the present invention.

FIG. 13 is a graphical representation of a data management system in accordance with an embodiment of the present invention.

FIG. 14 is a graphical representation of a base charger unit for a device in accordance with an embodiment of the present invention.

FIGS. 15A-C are logical flow diagrams illustrating an exemplary embodiment of the system in accordance with an embodiment of the present invention.

### DETAILED DESCRIPTION

Reference is now made to the drawings wherein like numerals refer to like parts throughout.

As used herein, the terms “location coordinates” refer without limitation to any set or partial set of integer, real and/or complex location data or information such as longitudinal, latitudinal, and elevational positional coordinates.

As used herein, the terms “tracking device” refers to without limitation to any integrated circuit (IC), chip, chip set, system-on-a-chip, microwave integrated circuit (MIC), Monolithic Microwave Integrated Circuit (MMIC), low noise amplifier, power amplifier, transceiver, receiver, transmitter and Application Specific Integrated Circuit (ASIC) that may be constructed and/or fabricated. The chip or IC may be constructed (“fabricated”) on a small rectangle (a “die”) cut from, for example, a Silicon (or special applications, Sapphire), Gallium Arsenide, or Indium Phosphide wafer. The IC may be classified, for example, into analogue, digital, or hybrid (both analogue and digital on the same chip and/or analog-to-digital converter). Digital integrated circuits may contain anything from one to millions of logic gates, invertors, and, or, nand, and nor gates, flipflops, multiplexors, etc. on a few square millimeters. The small size of these circuits allows high speed, low power dissipation, and reduced manufacturing cost compared with board-level integration.

As used herein, the terms “wireless data transfer”, “wireless tracking and location system”, “positioning system,” and “wireless positioning system” refer without limitation to any wireless system that transfers and/or determines location coordinates using one or more devices, such as Global Positioning System (GPS). The terms “Global Positioning System” refer to without limitation any services, methods, or devices that utilize GPS technology that determine a position of a GPS receiver based on measuring signal transfer times between satellites having known positions and the GPS receiver. The signal transfer time for a signal is proportional to a distance of the respective satellite from the GPS receiver. The distance between the satellite and the GPS receiver may be converted, utilizing signal propagation velocity, into the respective signal transfer time. The positional information of the GPS receiver is calculated based on distance calculations from at least four satellites.

As used herein, the terms “APGS”, “Assisted GPS”, or “A-GPS”, refers to without limitation any services, methods, or devices that utilizes an assistance server to help reduce required time to determine a location using GPS (such as in urban areas, when the user is located in “urban canyons”, under heavy tree cover, or even indoors). The development of APGS is fuelled, in part, by the U.S. Federal Communications Commission's E911 to have location coordinates of a mobile device available to emergency call dispatchers. In A-GPS networks, the receiver, has limited processing power and normally under less than ideal locations for position fixing, and communicates with the assistance server that has high processing power and access to a reference network. Since the A-GPS receiver and the Assistance Server share tasks, it provides a capability to provide more efficient location tracking capability than regular GPS, and improved cellular coverage.

As used herein, the terms “wireless communication system” refers to, without limitation, any system that uses communication stations and a wireless location means for determining positional coordinates such as Global Positioning Radio Service (GPRS).

As used herein, the term “network” refers to any telecommunications network, data network, or Voice Over IP (VOIP) network such as, without limitation, satellite, radio, microwave, millimeter-wave, RF wireless, RF cable, optical, and networking protocols (such as IEEE 802.11g), transmission media, and communications connections any combinations thereof.

As used herein, the term “server” refers to any computer element that stores or transfers data, information, or computer applications between one or more computer devices, such as mobile phones, laptop computers, user computer terminal, or the like, utilizing a network.

Overview

In one salient aspect, the present invention discloses apparatus and method of providing a system, including tracking devices, back-end systems, web interfaces, and voice interfaces, to calculate, monitor, and display, inter alia, location coordinates of a first tracking device. In particular, the first tracking device has a first transceiver. The first transceiver receives a first request signal from a remote user terminal that provides advantageously selective sharing of location information of the first transceiver. The first transceiver transmits a first reply signal including a first identification code. The second tracking device has a second transceiver. The second transceiver advantageously provides for receiving the first reply signal and comparing the first identification code to a stored identification code. Upon verification of the first identification code, the second transceiver calculates the location coordinates of the first tracking device without the need for the first tracking device directly connecting to GPS satellites. The second transceiver communicates a second reply signal to the monitoring station. The second reply signal comprises the location coordinates. Furthermore, if the location coordinates of the first device violates one or more rules defined by a subscriber of the location tracking system, the subscriber (or a designated guardian or representative) may be notified through, for example, wireless telephone, plain old telephone system (POTS), Internet, text message, email, vibration, sound, voice, or the like.

Broadly, the present invention generally provides a system and method for locating and tracking an individual or an object. The system produced according to the present invention may find beneficial use for locating and tracking people, such as missing, lost, or abducted persons, Alzheimer's syndrome patients, or mentally ill persons. The system may also be useful for locating and tracking animals. Additionally, objects, such as vehicles, goods, and merchandise may be located and tracked with the system produced by the present invention. Although the following discussion may use lost or abducted child as an exemplary demonstration, it is to be understood that this discussion is not limiting and that the present invention may be used in other suitable applications.

The present invention may be used to locate and track a tracking device concealed on an individual in one (or more) form factor(s). Form factors may include a pen carried in a pocket or backpack, an inner surface of a shoe, a button, a necklace, a toy, a shirt collar, decoration, fabric of a jacket or sweater, or the like. In addition, different device skins are available to camouflage a tracking device. For instance, a device skin, such as a plastic sticker or housing, attaches to a tracking device to blend the tracking device appearance with that of an object or individual to monitor. Consequently, in the event of abduction, an abductor is unlikely to remove and discard a concealed tracking device as compared to conventional tracking devices. For example, conventional tracking devices may be incorporated as part of a conspicuous device, such as with or part of a mobile phone, pager, personal data assistant or any other recognizable electronic device. Furthermore, the present invention discloses, in one embodiment, a substantially waterproof and shockproof device and, in one instance, substantially sealed and having no exposed metal contacts or other distinguishing features so as to camouflage it from its surroundings. Consequently, if submerged in water (such as when the tracking device is inadvertently washed in a washing machine as part of laundry) or exposed to cold temperature conditions, e.g., snow, the tracking device remains functional.

Additionally, conventional systems depend upon maintaining direct outdoor line-of-sight communication between a global positioning system (GPS) satellite and a tracked object. The system of the present invention does not require direct line-of-sight and the system effectively locates and tracks individuals and objects in indoor situations. Furthermore, assisted (a.k.a. advanced) global positioning system (AGPS) techniques may be utilized if the device cannot be locked onto global positioning system (GPS).

Conventional systems often require a user to manually activate a location system before signals can be communicated between the user and a person attempting to locate. In one embodiment of the present invention, the system may be passive so a user may remotely activate the tracking device, instead of the tracking device remaining constantly on, upon the user attempting to locate the tracking device. In yet another embodiment of the invention, no action is required on the behalf of an individual having the tracking device being located and tracked. In yet another instance, one or more tracking devices, e.g., a second tracking device, a third tracking device, a fourth tracking device, a fifth tracking device . . . may be remotely activated (in a cluster mode) to monitor and determine location coordinates of the first tracking device (and/or differential location coordinates from a second tracking device).

In yet another instance, one or more tracking devices are changed to a non-transmitting state, e.g., quiet mode or stealth mode, to make these tracking devices undetectable to unauthorized individuals. For instance, tracking devices on drug enforcement officers toggle to a stealth mode upon realizing (or suspecting) drug trafficking suspects are tracking them. In yet another instance, a first tracking device and a second tracking device are remotely monitored by using a wireless device, such as a mobile or cell phone, through a monitoring station.

Exemplary Extension Apparatus—

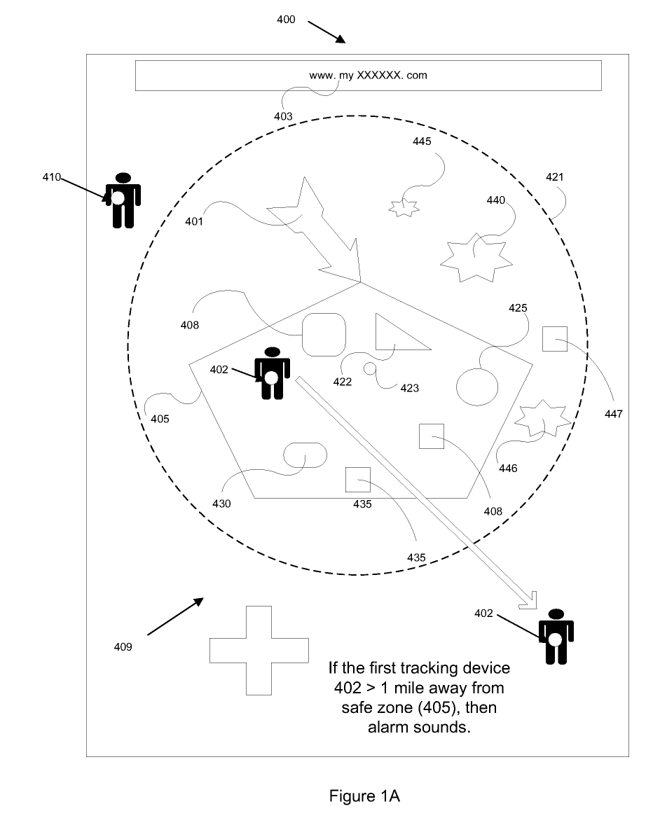

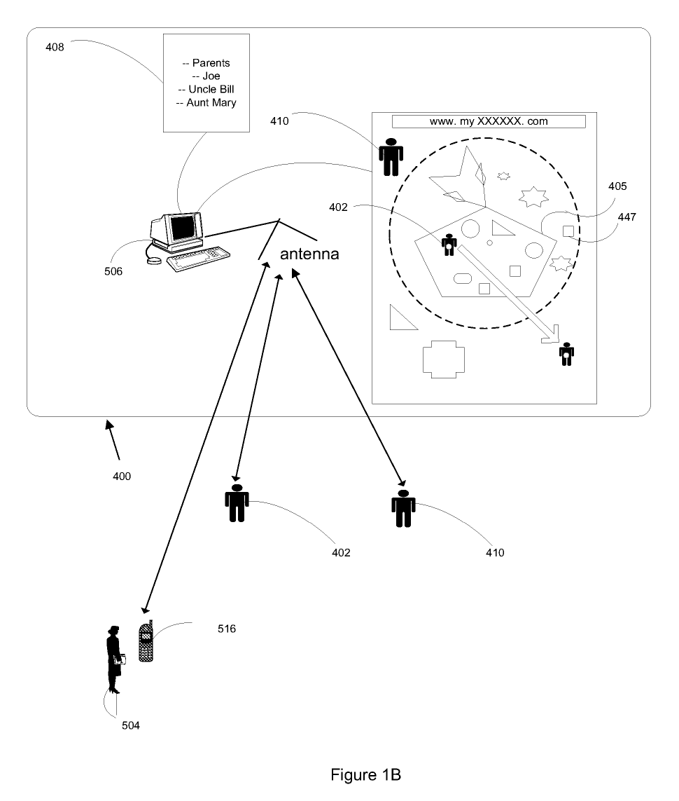

Referring now to FIGS. 1-5 and 8-14 exemplary embodiments of the tracking and monitoring system of the invention described in detail. It will be appreciated that while described primarily in the context of tracking individuals or objects, at least portions of the apparatus and methods described herein may be used in other applications, such as for example and without limitation. Some applications include control systems that monitor components such as transducers, sensors, and electrical and/or optical components within an assembly line process.

Moreover, it will be recognized that the present invention may find utility beyond purely tracking and monitoring concerns. For example, the “tracking device” and “user-defined mapping criteria” described subsequently herein may conceivably be utilized to improve other applications; e.g., increasing functionality and electrical properties of circuits utilized to improve computational efficiency and increase accuracy of calculated quantities. The calculated quantities may include velocity of objects traveling through an assembly line process for determining which portions of the process are running efficiently and which portions may require process improvements or modifications. Other functions might include module assembly (e.g., for purposes of providing transceivers that provide multiple methods and user choices for displaying electrical properties and measurement parameters during testing and/or operations before, during or after wireless module completion, and so forth). Myriad of other functions will be recognized by those of ordinary skill in the art given the present disclosure.

FIGS. 1A and 1B illustrate a positioning and tracking system 400 for defining an arbitrary shaped safe zone 405 in accordance with an embodiment of the present invention.

Referring to FIG. 1A, an image selection tool 401, e.g., screen pointer, is utilized to select a visually cognizable rendering of an area, e.g., selecting at least a portion of an area, on a subscriber interface 403, e.g., a web-based interface. The area selected by the image selection tool 401, for example, may be a safe zone 405. The safe zone 405 is an area that a user (a subscriber) specifies as a low injury risk area for individuals and/or objects. The safe zone 405 defined or described is specified utilizing one or more parameters. For instance, the safe zone 405, e.g., a home zone, may be specified, e.g., be establish by a user-defined mapping criteria using any of the following parameters: zip code boundaries, addresses, landmarks, buildings, mountain ranges, a WiFi hot spot, and distances from a specified location, such as one chosen by a subscriber. Upon the first tracking device 402 possessed by an individual traveling more than one mile from the safe zone 405, an alarm alert is sent to a user. In yet another example, an alarm is sent when the first tracking device 402 travels outside of a circularly shaped boundary 421 about a location 423, such as a WiFi network located in a coffee shop or “WiFi hot spot” designed area, within the safe zone 405.

Furthermore, the system 400 allows a user to draw an area, such as a safe zone 405, which may be an arbitrary shaped zone, e.g., a closed shaped user-defined polygon or a circle. For instance, a parent and/or scoutmaster may enter the safe zone 405 that encompasses a small neighborhood 408, a school campus 425, a stadium 430, a national park 435, or the like, and excludes other areas such as an automobile repair shop 440, warehouse 445, and high automobile traffic areas 446. Upon a child having the first tracking device 402 leaving the user-defined polygon region, e.g., the safe zone 405, an alert such as an audible alarm will be sent to a parent or guardian of the child.

As shown in FIG. 1B, the system 400 attempts to contact individuals on a notification list 408 if the child enters a danger zone, such as a riverbed 447. The notification list 408 may be prepared in a subscriber-defined order. For instance, if a user 504, such as one of the parents, is first on the notification list 408, the system 400 communicates a message to the user 504 using email, SMS, voicemail, and telephone call. In one optional feature, an individual on the notification list 408 is required to confirm receipt of the message. Otherwise, the system 400 continues to contact other individuals on the notification list 408 until it receives a confirmation message from that individual. In another embodiment, the system 400 is time limited so that monitoring may be enabled or disabled based on or in response to user-defined features. Such user-defined features may include enabling or disabling monitoring during a specific time of day or day of the week.

For instance, the tracking features may be shut off on Saturday or Sunday or when the child is located in the home. In one variation of the present embodiment, multiple individuals or subscribers may establish (or share (e.g., pool) existing or newly established) user-defined features; including safe zones or periods, which may apply to one or multiple tracking devices, such a first and second tracking devices 402, 410. The pooling of subscriber's tracking devices provides an added benefit including synergy and sharing of electronic data so that one tracking device can benefit from electronics and/or positional location of other tracking devices. For example, a low signal level tracking device can utilize a nearby tracking device, such as one owned by another subscriber, to triangulate their signal to a satellite of a wireless tracking and location system, such as GPS satellite system. In yet another example, a low signal level-tracking device can utilize location coordinates of a nearby tracking device as its own so that a user 405 can determine an approximate location of the low level-tracking device.

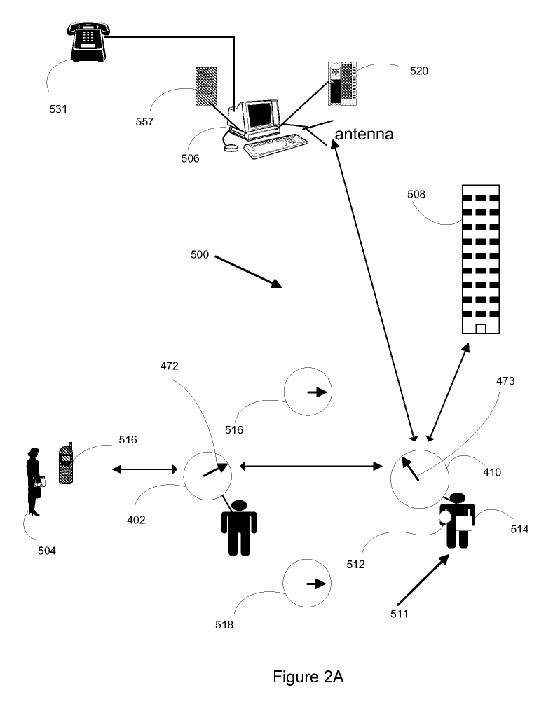

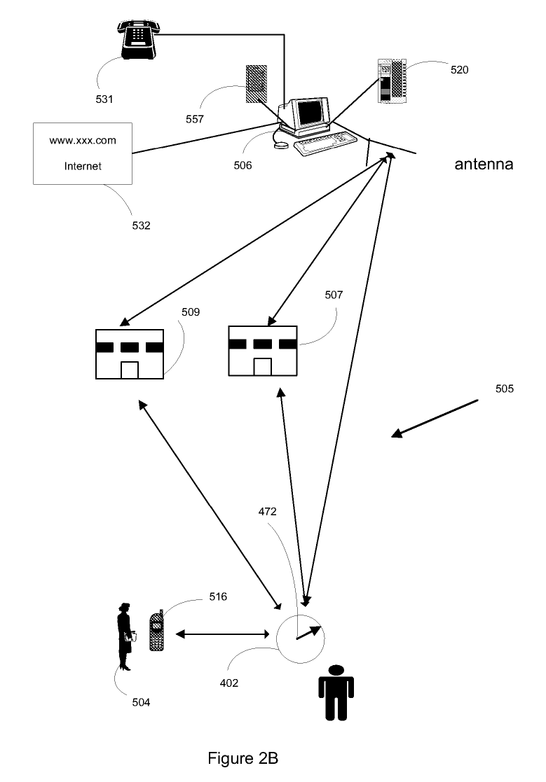

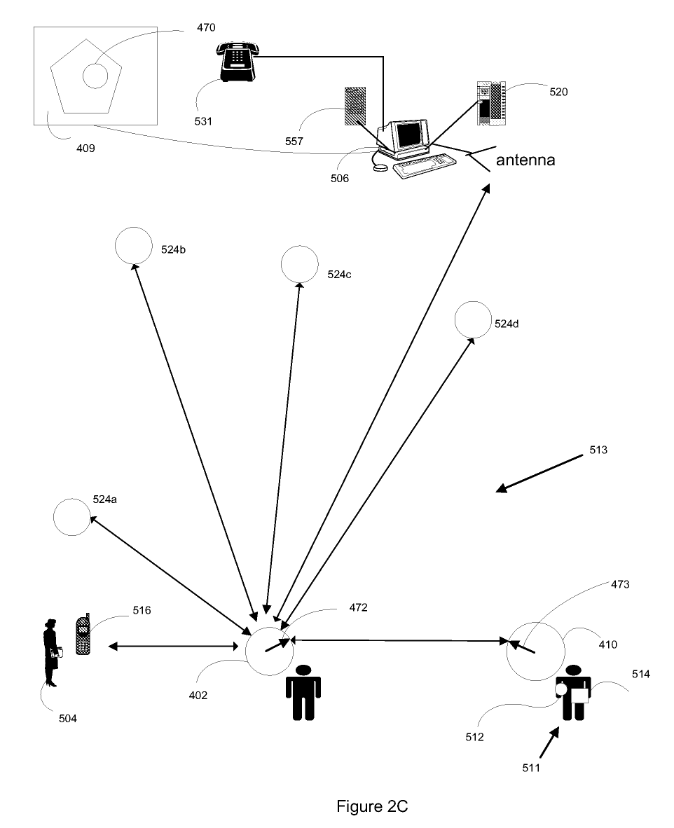

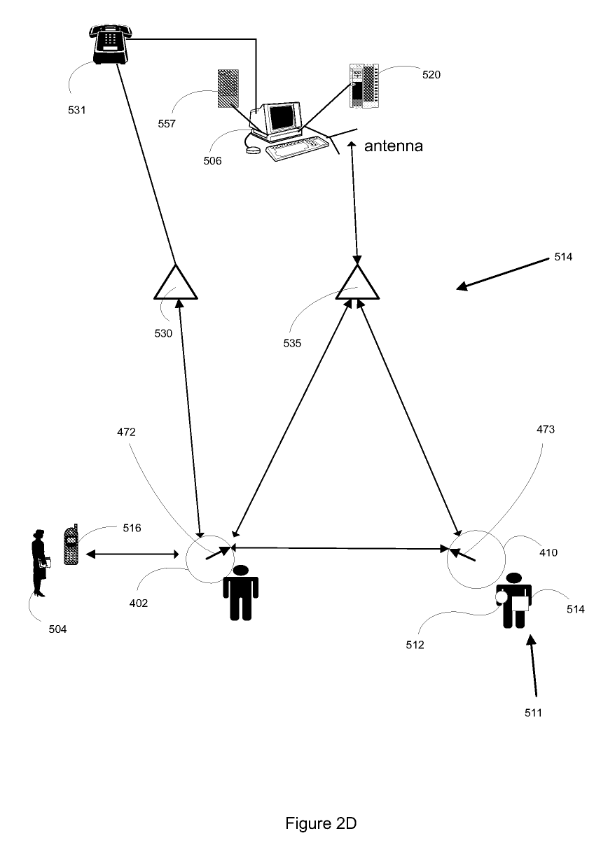

FIGS. 2A, 2B, 2C, and 2D illustrate a positioning and tracking system 500 for locating the first tracking device 402. Referring to FIG. 2A, the first tracking device 402 may optionally be hidden in a remote location, camouflaged, and/or incorporated as part of an individual's clothing and/or object and/or object's packaging. In one exemplary instance, the first tracking device 402 is located inside a button of a sweater of the individual being tracked. The first tracking device 402 may be, in a variation of the present embodiment, pre-programmed with an identification code (e.g., a first identification code). The identification code, in one embodiment, uniquely identifies the first tracking device 402 and prevents unauthorized individuals accessing the first tracking device 402. The first tracking device 402 may be activated by an individual possessing the first tracking device 402. In one alternative, the device 402 can be remotely activated by a user 504, a monitoring station 506, a nearby base station 508, and/or a second tracking device 410. The system 500 may transmit the user's identification code (a second identification code) to the first tracking device 402, which user's identification code prevents unauthorized access to the first tracking device 402 to reduce the possibility of unauthorized device monitoring.

In one embodiment, the monitoring station 506 receives a location request and user's identification code from the user 504. Afterwards, the monitoring station 506 transmits a signal that includes the user's identification code. The location request may be from the user 504 for location data associated with the first tracking device 402. When the user 504 seeks to locate and track an object, such as a first tracking device 402, the user 504 may issue the location request to the monitoring station 506 using a communication device 516, such as a cellular phone or Personal Communications System (PCS) telephone. In other embodiments, the device 516 may be any of the following: a land-based telephone (“landline”), a computer connected to the Internet, a personal digital assistant, a radio, a pager, hand delivery or the like. The user 504 may provide the monitoring station 506 with the user's identification code to prevent unauthorized tracking. In one example, the second tracking device 410 utilized by the user 504 determines location coordinates of the first tracking device 402, in this example, that is also owned by the user 504.

As shown in FIG. 2A, the second tracking device 410 receives a signal of a designated signal strength that includes the user's identification code. The second tracking device 410 is disposed on a second individual 511, such as a second child. The second tracking device 410 may be concealed and secured, e.g., sewn, glued, or taped, into a portion of the clothing 512 if desired. For instance, the second tracking device may be part of or concealed within a button, sweater, shirt, pocket, sleeve, or the like. In another alternative, the second tracking device 410 may be incorporated and concealed as part of the second individual's belongings 514, such as wallet, pen, pencil, tape recorder, or the like.

In yet another alternative, at least one of the first and the second tracking devices 402, 410 may be packaged in a waterproof and shockproof electronic package, such as a heat or temperature resistant plastic coating or composite material plastic housing (in one embodiment the composite plastic housing may be a substantially one piece, sealed, polycarbonate abs material). Continuing with the same embodiment, because the device is extremely rugged, it can operate under extreme weather and temperature conditions, such as during freezing weather conditions, e.g., during a snowfall, and also durable enough to be accidentally cycled through a clothing washer and/or dryer cycle without significant loss of functionality. In one variant of the present embodiment, when the first and/or the second tracking devices are completely sealed, there are no exposed metal contacts, no buttons to press, no lights to flash, and no sound to alert an unauthorized person that a tracking device is present.

In yet another embodiment, different device “skins”, such as plastic stickers or plastic covering, are available, similar to those used to change an appearance of a mobile phone, to further camouflage. As previously discussed, a multitude of form factors are available to conceal a tracking device (such as disposing the tracking device with keychain, a belt buckle, a shoe insert, a necklace, a toy, a decoration, or the like).

In yet another embodiment, in the event that a tracking device is forcibly removed from an abducted child, discarded, and later retrieved, a surface of the composite plastic surfaces provides an increased capability to obtain fingerprints of a suspected assailant. In one embodiment, a smooth shiny composite plastic surface on a tracking device retains fingerprints, which may be collected using accepted forensic fingerprint processing techniques known by those skilled in the art. In yet another embodiment, a thin-film plastic or rough composite plastic surface disposed on a tracking device retains fingerprints, which also may be collected using accepted forensic fingerprint processing techniques known by those skilled in the art.

Referring to FIG. 2A, the second tracking device 410 compares a stored identification code with the user's identification code. If the identification codes match, e.g., are verified, then the second tracking device 410 requests information from the first tracking device 402. The second tracking device 410, in this example, requests information, such as last known or last location coordinates (such as longitudal, latitudinal and elevational position, an address, a nearby landmark and the like) from the first tracking device 402. For instance, data or positional information is determined using a wireless location and tracking system, such as GPS satellite system.

The second tracking device 410 sends a positioning signal to the first tracking device 402. Afterwards, the first tracking device 402 sends a return positioning signal. Continuing with this example, at the second tracking device 410, a phase difference and/or time delay signal is generated between the positioning signal and the return positioning signal. The phase difference and/or the time delay is converted to a delta distance between the tracking devices 402, 410 utilizing a propagation velocity of the signaling area, for example air. The second tracking device 410 communicates the delta distance and tracking data of the second tracking device 410. The delta distance and the tracking data are utilized to calculate the location coordinates, e.g., last known location or present location coordinates, of the first tracking device 402. Afterwards, the location coordinates of the first tracking device 402 are communicated by the second tracking device 410 to any or all the following: the user 504, the nearby base station 508, and monitoring station 506.

For calculating a velocity or relative change in velocity of the first tracking device 402, the relative distance, as discussed above, is calculated for multiple periods, e.g., at discrete or sequential time intervals. Distance calculations at various time intervals are utilized to determine rate of change of the tracking device 402. The rate of change, in this example, directly relates to a velocity or a relative velocity that the first tracking device 402 is moving relative to the second tracking device 410. In the alternative, the first tracking device 402 may be measured relative to another designated stationary, moving object, a tree, landmark, or WiFi network, such as one from at a local coffee shop. In one embodiment, a warning signal, which may consist of an audio response or a light display, such as pulsing light array, would result if the first tracking device 402 has a calculated velocity faster than a subscriber, e.g., user 504, set limit. For example, upon a child possessing the first tracking device 402 being detected traveling more than 60 mph, e.g., above a 55 mph limit set by the subscriber, a warning signal, such an electrical stimulation, light, sound, or the like, will be sent. The warning signal is sent to at least one of a subscriber, e.g., such as user 504 to indicate their child may have been abducted or driving an automobile faster than 55 mph, or to the child, e.g., that warns a teenager to stop driving so fast. Furthermore, the warning signal provides an audible measure of the first tracking device 402 traveling further away or closer to the second tracking device 410 without the need for the subscriber interface (as described in FIGS. 1A, 1B) to monitor the first tracking device 402.

In one variation of this embodiment, the first tracking device 402 or the second tracking device 410 may have a compass 472, 473 respectively and, in one optional step, provide a warning signal to a user 504 or an individual possessing the tracking device 402. In one application, a first boy scout has the first tracking device 402 and a scoutmaster has the second tracking device 410 so that each may determine a relative direction (and or relative movement) from each other where GPS is not available. Furthermore, the compasses 472, 473 provide discrete and private directional information so the second tracking device 410 may locate another tracking device, e.g., a first tracking device 402, without supervision and/or support of a user 504 and/or the monitoring station 506.

In the above example, the second tracking device 410 utilizes the location information stored in the first tracking device 402 when the first tracking device is out-of-range of GPS positioning satellites. Consequently, positional information and/or coordinates of the first tracking device 402 may be advantageously measured even when the first tracking device 402 is out of range (or RF shielded from), for example, of a minimum number of required GPS satellites. In yet another embodiment, additional tracking devices, a third tracking device 516 and a fourth tracking device 518, may be provided. These additional tracking devices provide additional relative distance measurements from the first tracking device 402. Consequently, these additional devices utilized as part of triangulation distance calculations may potentially increase accuracy of location coordinates of the first tracking device 402.

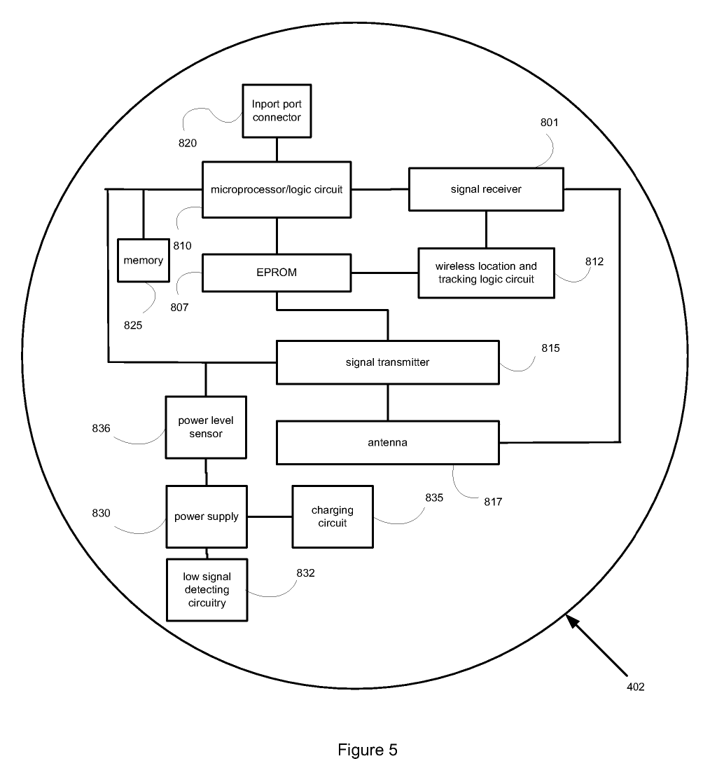

Referring to FIG. 2B, a first mobile transceiver station 509 communicates between the first tracking device 402 and the monitoring station 506. A second mobile transceiver station 507 communicates between the first tracking device 402 and the monitoring system 506. The monitoring station 506 remotely accesses the first tracking device 402 through a subscriber interface, such as subscriber interface 403 in FIGS. 2A and 2B. The subscriber interface 403 (shown in FIG. 1A) provides a screen pointer tool 401 to the subscriber (user) 504 for selecting an arbitrary shaped zone, e.g., the safe zone 405, on a map 409. Using the subscriber interface 403, the subscriber 504 communicates a first request for position coordinates of a first tracking device 402. Furthermore, the first tracking device 402 has a first transceiver, e.g., including a signal receiver 801 and a signal transmitter 815 shown in FIG. 5, to receive the first request signal and to transmit a first reply signal that comprises a first identification code. The first tracking device 402 receives a second identification code from a monitoring station 506 and compares this code to a stored identification code.

In this same embodiment, upon determining that the second identification signal code matches the stored identification code, the signal transmitter 815 (see FIG. 5) transmits its last position coordinates to the monitoring station 506. In one variation of this embodiment, low signal detection circuitry monitors received signal strength of a positioning signal. Upon the low signal detection circuitry 832 (see FIG. 5) determining received signal strength, such as when the positioning signal, e.g., global positioning signal, is detected above a defined level, the first tracking device 402 switches to a wireless location and tracking mode, e.g., GPS mode, receives positioning signal coordinates, and stores these coordinates as its current position coordinates. In this example, the user 504 provides the location request to the monitoring station 506 by at least one of a telephone communication (such as by POTS 531 or mobile phone 516) and an electronic message via Internet 532. The monitoring station 506 provides, in one example, the position signal to the user 504 as an electronic message over the Internet 532. In another alternative, the monitoring station 506 may provide the position signal to the user 504 as a voice message when the user 504 provides the location request by a telephone communication (such as POTS 531 or the mobile phone 516).

The location request and any response from the monitoring station 506 may be sent to a server 520. The server 520 may be used in cooperation with the monitoring station 506 for verifying information transmitted and received between the user 504 and the monitoring station 506. The monitoring station 506 may include a database 557 for storing the user's identification code sent by the user 504. The monitoring station 506 may compare the user's identification code received with the location request to the stored identification code in the database to determine if the user's identification code (received from the user 504 with the location request) is valid. In these embodiments, the systems 500, 505, 513, and 514 may communicate in data format only; therefore, the systems 500, 505, 508, and 510 will not compete for costly voice spectrum resources. Consequently, the present invention does not require the use of a mobile identification number (MIN). The identification codes (first identification code and second identification code) may comprise an electronic serial number (ESN).

Referring to FIG. 2C, the first tracking device 402 travels within direct-line of sight of a wireless data transfer and or wireless location and tracking system. One exemplary example, the wireless data transfer and/or wireless location and tracking system is Global Positioning System (GPS). GPS satellites, for example 524a-d, calculate location data (such as a longitudinal, latitudinal, and elevation position, an address, a nearby landmark, and the like) of the first tracking device 402. The time it takes a global positioning system signal from a GPS satellite 524a-d to reach the first tracking device 402 is utilized to calculate the distance from the GPS satellite 524a-d to the first tracking device 402. Using measurements from multiple GPS satellites (e.g., four GPS satellites 524a-d), the system 513 triangulates a location for the first tracking device 402. Triangulation provides latitude and longitude information by comparing the measurements from the multiple GPS satellites 524a-d to the first tracking device 402. The measurements may include distances between two or more GPS satellites 524a-d and relative orientations of the GPS satellites 524a-d to the tracking device 402 and the earth. In this embodiment, the location 470 of the first tracking device 402 is, for example, updated, on any of the following update schedules: a continuous, automatic, periodic, and/or upon user request. When the user 504 requests a communication update, the location 407 is communicated to the monitoring station 506.

At the monitoring station 506, the location 470, in one embodiment, is stored. Upon a user 504 requesting the location 470 of the first tracking device 402 on their wireless device, e.g., the cell phone 516 or the like, the location 470 is displayed on a user-defined map, such as shown at map 409 in FIG. 1A. Furthermore, the monitoring station 506 may track also the second tracking device 410 on the display 400 (shown in FIG. 1). As such, location coordinate measurements and warnings of the first tracking device 402 and the second tracking device 410 may be coordinated, monitored, and/or tracked, including relative distances between the devices 402, 410. The user 504 may remotely monitor the devices 402, 410 using the cell phone 516.

In contrast, conventional monitoring systems had limited capability of monitoring multiple tracking devices, such as requiring a centralized monitoring station, limited remote access to tracking device information for users, and limited mapping capabilities. In the present invention, the monitoring device 506 and the cell phone 516 allow multiple tracking devices, such as 402, 410, to be remotely monitored, coordinated and distance within or from a safe zone calculated, even when not within a line-of-sight of a wireless location and tracking system. Furthermore, a user 504 defines the safe zone 405, as shown in FIG. 1A, which option increases display monitoring accuracy by providing precise boundaries for safe and unsafe zones and displaying the first and second tracking devices either inside or outside the boundary.

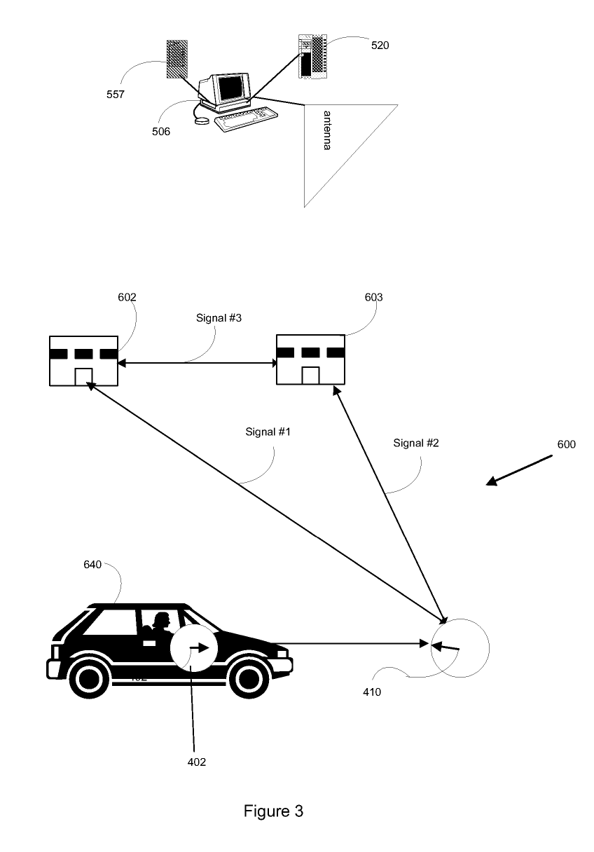

Referring to FIG. 2D, another wireless data transfer, and wireless location and tracking system is disclosed. This system includes a first transmitter/receiver station 530, e.g., a base station, for communicating between the first tracking device 402 and monitoring station 506. The first transmitter/receiver station 530 may be connected to a wireless network operator (not shown) and a public switched telephone network (PSTN) 531. A user's identification code may be sent within a signal to the first transmitter/receiver station 530. The signal may then be sent from the first transmitter/receiver station 530 to the tracking device 402. In the system 514, a second transmitter/receiver station 535 may be utilized to locate and track the first tracking device 402. The second transmitter/receiver station 535, in this example, communicates location coordinates between the first tracking device 402, the second tracking device 410, and the monitoring station 506. By triangulating positional coordinates between and among the first and second stations 530, 535 of the first tracking device 402, similar to discussions associated with FIGS. 2a-d and FIG. 3, location coordinates of the first tracking device 402 are computed.

FIG. 3 illustrates a positioning and tracking system utilizing a wireless communication system to determine location coordinates for the first tracking device in accordance with an embodiment of the present invention. In this example, the wireless communication system (WCS) is General Packet Radio Service (GPRS). General Packet Radio Service (GPRS) signals locate and track the first tracking device 402. GPRS is a non-voice service that allows information to be sent and received across a mobile telephone network. GPRS may supplement Circuit Switched Data (CSD) and Short Message Service (SMS). In yet another exemplary wireless data transfer and/or wireless location and tracking system, upon the first tracking device 402 not being accessible by GPS or other communication means, a plurality of transmitter/receiver stations may be utilized. For example, the first transmitter/receiver station 602, e.g., a mobile base station, and the second transmitter/receiver station 603, e.g., a mobile base station, may be deployed. These stations 602, 603 send location coordinates of the first tracking device 402 through the second tracking device 410 and the monitoring station 506. The first transmitter/receiver station 602 communicates with the second tracking device 210 with Signal #1. The second transmitter/receiver station 603 communicates with the second tracking device 410 with Signal #2. In this same example, Signal #3 may serve to communicate between the first transmitter/receiver station 602 and the second transmitter/receiver station 603.

By triangulating the location of the second tracking device 410, a location may be determined for the second tracking device 410. Following, a relative distance, as discussed above in FIGS. 2a-d, is determined between the second and the first tracking devices 410, 402. Afterwards, the location coordinates of the first tracking device 402 are obtained using the location of the second tracking device 410 and a delta distance, e.g., relative distance, of the first tracking device 402 from the second tracking device 410.

The tracking device 402 may be associated with an object, such as an automobile 620. By placing the first tracking device 402 anywhere within or on the automobile 640, the system 600 may locate and track the automobile 640. Likewise, the system 600 may be used for locating and tracking an individual. The individual, such as a child, may be located and tracked when the individual, such as shown in FIGS. 2a-d, possesses the first tracking device 402. For example, the individual (similar to the individual in FIG. 2 for the second tracking device 410) may carry the first tracking device 402 in a pocket in the individual's clothing, in a backpack, wallet, purse, a shoe, or any other convenient way of carrying. As described above, locating and tracking the individual may be accomplished through use of a Signal #1 and #2.

It is to be understood that although the automobile 640 and the individual are herein used to exemplify locating and tracking, the system 600 may be used to locate and track many other objects, inanimate (such as merchandise or any vehicle, vessel, aircraft, etc.) and animate (such as pets, domesticated animals, or wild animals).

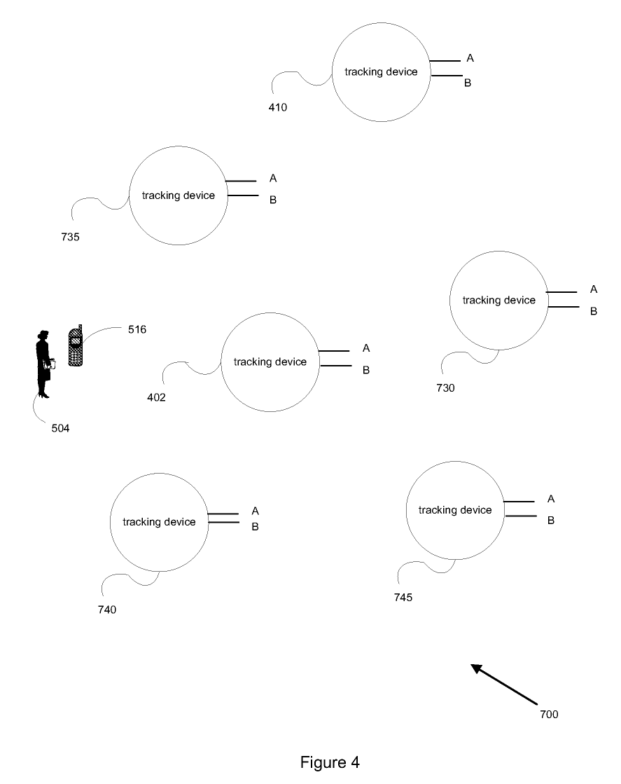

FIG. 4 shows a plan view of a positioning and tracking system 700 for locating a first tracking device 402 using other user's tracking devices. In one variation of FIG. 1, a user 504 may receive permission or previously have received permission to utilize the tracking device 735. In this example, the tracking device 735 is owned by another user. When the tracking device 735 is located within a communication range of the first tracking device 402, the user 504 may request its use by providing a proper identification number. In yet another variation, groups of users, such as owner's of tracking devices 730, 735, 740, and 745, etc. may pool their resources so that any of these devices are available to others in the group.

In other words, the group of owners for 730, 735, 740, and 745 may utilize other users tracking devices, e.g., like those near a desired device to track. In one alternative embodiment, each of the group of owners shares security codes. In this alternative embodiment, each owner of the group has permission to limit usage of their tracking device to others of group members (as well as others outside of the group of users). Furthermore, each of the tracking devices 730, 735, 740, and 745 may have one or more communication channels, such as A, B, C, D, etc . . . . Consequently, multiple users of the group may utilize different channels on the same tracking device(s) to determine location coordinates in a substantially simultaneous and/or sequential manner for each of their tracking devices during a specified period (for example one specified by a subscriber). For instance, the tracking device 730 may have four communication channels, e.g., A, B, C (not shown), D (not shown), where A is utilized to track the first tracking device 402 and B is utilized to track the second tracking device 410 during a substantially similar period.

FIG. 5 is a block diagram of the first tracking device 402 in accordance with an embodiment of the present invention. The tracking device 402 may comprise a signal receiver 801 for receiving a signal from the monitoring station 506 (shown in FIG. 2). The signal may include the user's identification code (second identification code), sent by the user 504 (shown in FIG. 2). The first tracking device 402 may comprise a microprocessor/logic circuit 810. The microprocessor/logic circuit 810 may store a first identification code to produce a stored identification code, determine a location of the first tracking device 402, and generate a position signal that contains location data (such as a longitudinal, latitudinal, and elevational position, an address, a nearby landmark, and the like) for the tracking device 402.

The first tracking device 402 may further comprise an erasable programmable read-only memory (EPROM) 807 for storing operating software for the microprocessor/logic circuit 810. A positioning system logic circuit 812 may be used for calculating location data (such as a longitudinal, latitudinal, and elevational position, an address, a nearby landmark, and the like) for the first tracking device 402 to be sent to the microprocessor/logic circuit 810 and subsequent transmission to the monitoring station 506 (shown in FIG. 2).

The first tracking device 402 may comprise a signal transmitter 815. In one embodiment of the invention, a single transceiver may be substituted for the signal receiver 801 and the signal transmitter 815. An antenna 817 may be connected to the signal transmitter 815 and an antenna 817 may be connected to the signal receiver 800. The signal transmitter 815 may allow the first tracking device 402 to transmit a signal to the monitoring station 506 (shown in FIG. 2) and thus transmit location data (such as a longitudinal, latitudinal, and elevation position, an address, a nearby landmark, and the like). The signal receiver 801 may allow the tracking device 402 to receive the signal from the monitoring station 506 (shown in FIG. 2) to allow the user 504 (shown in FIG. 2) to send a location request by at least one of a telephone communication and an electronic message via the Internet.

An input port connector 820 may be connected to the microprocessor/logic circuit 810 for inputting the stored identification code (first identification code) for storage in memory 825. The microprocessor/logic circuit 810 may be connected to receive operating power from a power supply 830. The power supply 830 may be any type of battery that is small enough to fit inside of the tracking device 402. A charging circuit 835 may be connected to the power supply 830 for recharging the power supply. The charging circuit 835, for example, may be a charging circuit such that an external magnetic battery recharger may provide recharging electricity to the charging circuit 835 for recharging the power supply 830 whenever the power falls below a predetermined level.

A power level sensor 836 may be connected between the power supply 830 and the microprocessor/logic circuit 810 for sensing the power level of the power supply 830 and providing the sensed power level to the microprocessor/logic circuit 810. The microprocessor/logic circuit 810 may generate a power level signal to be transmitted with the signal transmitted.

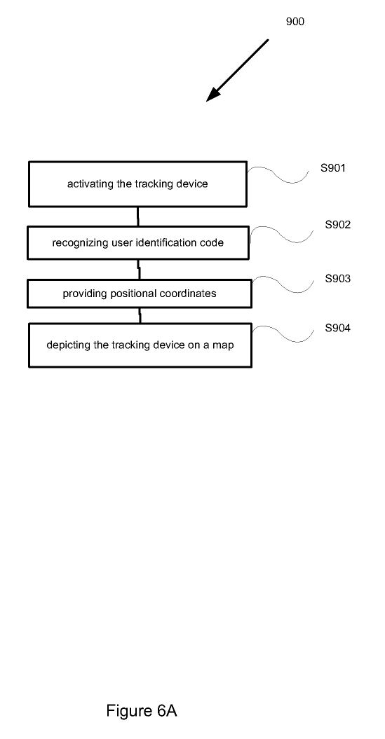

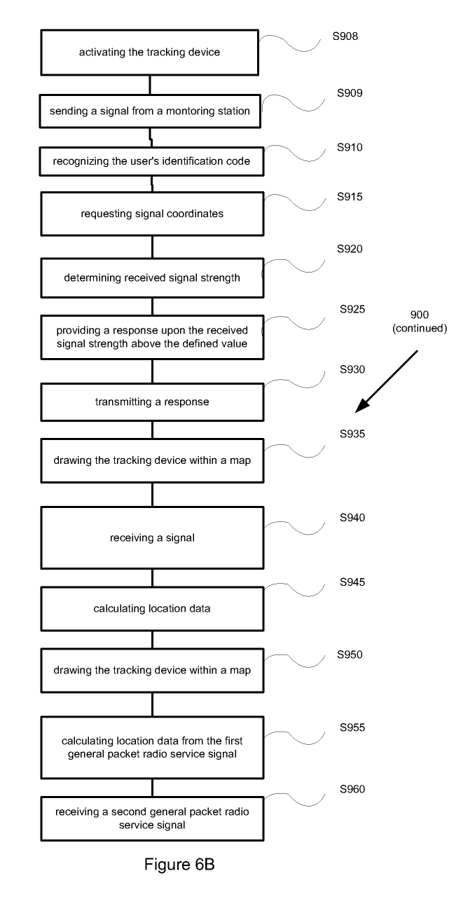

FIGS. 6A, 6B are a logical flow diagrams illustrating one exemplary embodiment of a method 900 for locating an individual or an object in accordance with another embodiment of the present invention. This method is based on components previously discussed in FIGS. 2a-d and 3.

As shown in one embodiment as depicted in FIG. 6A, a location request sent from a monitoring station is received at an activated tracking device (S901). Upon recognizing a user's identification code (S902), the activated tracking device's positional coordinates are provided (S903). A rendering of the activated tracking device is placed on a map; the map depicts the activated tracking device's position relative to a user designated safe zone (S904).

As shown in another embodiment as depicted in FIG. 6B, the tracking device is activated (S908). A monitoring station sends a signal and the signal is received at the tracking device—the signal includes a location request and optionally a user's identification code (S909). The tracking device recognizes the user's identification code as a location request pertaining to the tracking device (S910). System signal coordinates are being requested (S915). In step S920, a level of a received signal strength of the positioning satellite coordinates is determined if it is above a defined value (S920).

In one embodiment, upon the received signal strength being above the defined value, a response is formatted and provided for the location request including the positioning satellite coordinates, where the response includes location data pertaining to the tracking device (S925). The response is transmitted to a server (S930). The tracking device location is drawn within a map that comprises a safe zone (S935). The tracking device location is drawn within a map using a mapping service, such as the Kivera Location Engine™ provided by Kivera, Incorporated of Oakland, Calif., in the United States or the MapQuest™ mapping service provided by MapQuest, Incorporated of Denver, Colo., in the United States.

The mapping service may use location data, such as the longitudinal, latitudinal, and elevational position, to provide an address near the location tracked (“nearest location address”) comprising a street name, postal code (zip code) or a nearest known landmark. The mapping service may then forward the location data to the user 504 (FIG. 2) via the monitoring station 506 (FIG. 2).

The method may further comprise the additional step (S940) of receiving a positioning system signal from a positioning satellite, and a step (S945) of calculating location data from the positioning system signal. The method may further include the step (S950) of receiving a first general packet radio service signal from a first transmitter/receiver station.

The method may also include the step (S955) of calculating location data from the first general packet radio service signal. The method may further comprise the additional step (S960) of receiving a second general packet radio service signal from a second transmitter/receiver station and may comprise calculating location data from the second general packet radio service signal.

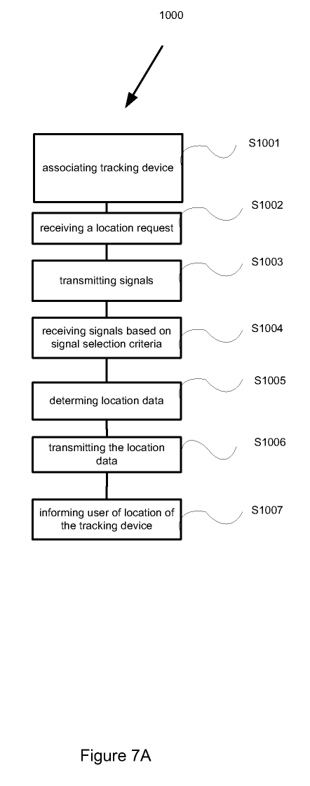

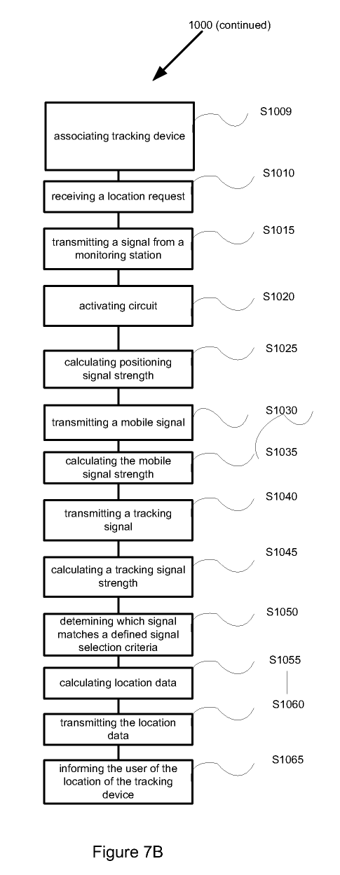

FIGS. 7A, 7B are logical flow diagrams illustrating another exemplary embodiment of a method for locating an individual or an object in accordance with another embodiment of the present invention. This method is based on components previously discussed in FIGS. 2a-d and 3.

In FIG. 7A, one embodiment of the method 1000 is disclosed. In this embodiment, a tracking device is associated with an individual or an object (S1001). A location request is received from a user (S1002). Signals are transmitted to the tracking device from one or more locations, for example, from a monitoring station, a wireless location and tracking station, a mobile transceiver, and an adjacent tracking device (S1003). Based on signal selection criteria, the tracking device selected at least one signal (S1004). The signal selection criteria, in one example, may be based on signal strength level, availability of signal, and/or ownership of a system providing the at least one signal. Location data is determined in part based on the signal selection criteria (S1005). The location data is transmitted to the monitoring station, for example, for further processing (S1006). A user is informed of the location of the tracking device on a map (S1007).

In FIG. 7B, another embodiment of the method for locating an individual or an object is disclosed. In this method, a tracking device is associated with the individual or the object to be located (S1008). A location request is received from a user (S1010). A signal is transmitted from a monitoring station to the tracking device (S1015). Following, a positioning system circuit is activated within the tracking device (S1020). A positioning signal strength of a received positioning system signal is calculated (S1025). A mobile signal is transmitted from a mobile transceiver to the tracking device (S1030).

A mobile signal strength is calculated of a received mobile signal (S1035). A tracking signal is transmitted from an adjacent tracking device (S1040). A tracking signal strength is calculated of a received tracking signal (S1045). Determining which of the positioning system signal, the received mobile signal, and the received tracking signal match a defined signal selection criteria stored in the tracking device (S1050).

Location data is calculated based in part on a signal selected utilizing the defined criteria (S1055). The location data is transmitted to the monitoring station for analysis to determine a location of the tracking device (S1060). A user is informed of the location of the tracking device on a map (S1065).

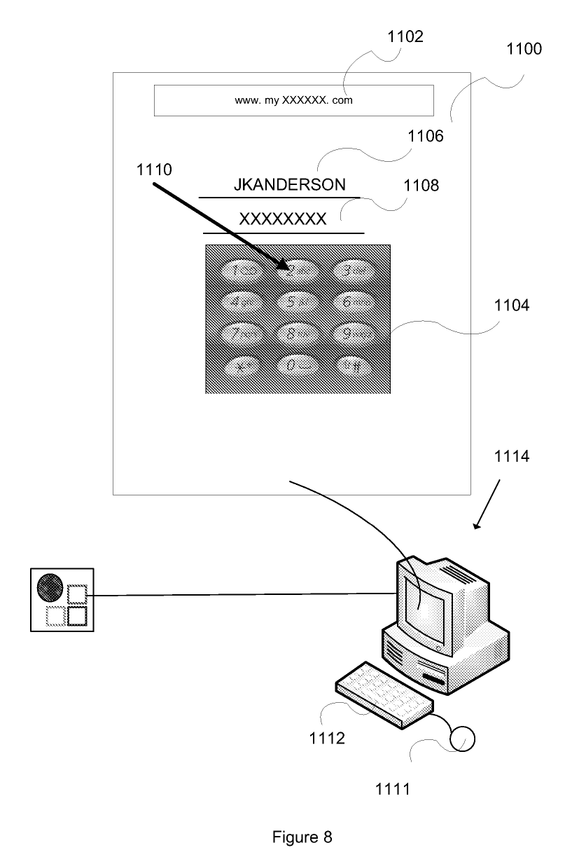

Referring to FIG. 8, a graphical representation depicts a user interface that is an embodiment of the present invention. The user interface, in this example, is provided on a computer screen 1100 as an Internet webpage 1102 to access a network database, e.g., a database 557 (as shown in FIG. 2D) that collects, stores, and retrieves location coordinates (and other associated information) for the device (such as the first tracking device 402 shown in FIG. 5). In this embodiment, the Internet webpage 1102, e.g., which may be either a secure or unsecured webpage, depicts a rendering of a numeric and letter entry device, e.g., keypad 1104.

For a subscriber (a customer) to utilize the user interface, account wizards, in one embodiment, may be utilized to direct the consumer to provide subscriber account information. In yet another example, a Customer Service Representative (CSR) receives subscriber account information using a plain old telephone system (POTS). Subscriber information collected includes desired Interactive Voice Response (IVR) language, user's identification code, email address, mailing address, time zone, telephone number, secret question/secret answer used for password reset, and billing information. In one embodiment, a cursor 1110 makes an entry on the keypad 1104 by clicking on a desired combined alpha/numeric key (such as keys associated with the letters JKANDERSON) on the keypad 1104. Also entering the user's identification code, a user's password (such users password 1108) is required. In one exemplary embodiment, a user's password may be numbers or letters (or a combination thereof), in this example, having of length of 7 to 20 digits. In another exemplary embodiment, a user's password may be only letters that represent a name of an object, place, or person (e.g., Benjamin), which password is represented as XXXXXXXX 1108 during password entry to protect from unauthorized viewing. In yet another embodiment, the user's keyword may be a combination of numbers and letters.

In contrast to conventional keypad entry systems, the keypad 1104, in this exemplary embodiment, advantageously allows entry of letters and numbers for the user's identification code 1106 and the user's password 1105. Thus, a subscriber recall of the user's identification code 1106 and the user's password 1108 may be improved through the additional flexibility of choosing familiar codes to potentially ease a login process. Another advantage of this system is because the user's identification code 1106 (e.g., selected by a subscriber) and the user's password 1108 (e.g., favorite pet, favorite number, favorite food, favorite car, favorite parakeet) are directly inputted on the Internet webpage 1100, no key strokes are entered on a keyboard, such as keyboard 1112, of a computer 1114. Accordingly, the invention advantageously provides a secure login by preventing the user's identification code 1106 and/or the user's password 1108 recorded and/or stored by spyware programs, e.g., keystroke recording software, upon inputted, on an unsecured website. Furthermore, the secure login, described above, may, in yet another embodiment, be utilized on a secure website.

Another advantage of this user interface over conventional numeric only systems is that the entry platform and footprint utilized during a login process (e.g., entry of user identification code and user password) on the Internet webpage 1102 replicates on other user entry platforms to access the network components, such as database 557 as shown in FIG. 2D. Other user entry platforms may include any of the following telecommunication systems: wireless telephone, a mobile phone, plain old telephone service (POTS), a Voice Over IP (VOIP) system, Interactive Voice Response (IVR) System or the like.

Activate Device

After successfully completing a login process into the network, a subscriber (e.g., user or customer) may activate a device, such as a first tracking device 402 as shown in FIG. 5. In one embodiment, activation of the device includes entering a device's serial number and placing the device on a device charger (such as one shown in FIG. 14). As the system attempts to provision the device on the network, a subscriber, in one example, creates a nickname for the device, e.g., chooses an icon that indicates what is being tracked, (e.g. person, pet, vehicle, asset, etc.). The subscriber may repeat this wizard to activate one or more other devices.

Create a Zone

Utilizing a zone creation wizard, a subscriber creates a first zone, for example, by selecting a center point (such as center point 423 depicted in FIG. 1A), a radius (e.g., a radius that creates circle 421 about the center point 423 depicted in FIG. 1A), and a notification list (e.g., a list 408 depicted in FIG. 1B). The notification list is utilized when the device is detected outside of the first zone. Other variables include scheduling when individuals on the notification list are notified (e.g., time of day and/or day of week). The subscriber may repeatedly use the zone creation wizard to create another zones (e.g., that may be concentric and/or within the first zone).

Manage Child's Profile

A device tracks a location of children or objects. The device network provides the capability to manage a child's information such as height, weight, allergies, medical history and photos. Consequently, the device network provides a valuable resource for law enforcement in the event a child is missing. Not only will designated representatives, such as law enforcement or child custody personal, be able to track the location of, for example, missing, lost, or suspected kidnapped children (e.g., using the first or second tracking devices 402, 410 in FIGS. 2A-2D and 4), but also have permission to access current photos and medical information to aid in their search.

Subscribers can manage the following information for a child. For instance, information may be provided such as name, nickname, height, weight, hair color, favorite foods, distinguishing characteristics (e.g. birthmarks), and the like. In one embodiment, each academic year, parents of the children are reminded to upload a current photo and update the profile. Parents may customize the information by assigning (or associating) child information with their own name/value pairs. Information may include medical history such as allergies, medications, disabilities, family doctor, and medical history. Multimedia information, in one embodiment, such as photos, short video, or audio clips may also be provided as documentation.

Additional information such as last known location, last known clothing, people last seen with, may be provided. This features allows the option of integration of features of objects to be tracked in one locations (e.g., a device network) so that authorized individuals (on a limited access or need to know basis) may obtain information on child to help tracking a suspected lost or missing child. Furthermore, a ‘no stalk’ feature allows a individual, such as a child, to be informed if another device has been tracking them for a extended period without violating the privacy of either party. For instance, subscriber may be provided information that another device has been tracking their children over, for instance, a three-hour period near a pre-defined danger zone, e.g.; address of one or more known sex offenders, without violating the privacy of either party.

Associate a Device with a Child's Profile

Once a device is configured and a profile is established, the device network will maintain an association between a device and a child's profile. Upon a device being re-assigned, a subscriber can re-assign a profile to a different device. Furthermore, as shown in FIGS. 2A, 2C, and 4, devices may form a “cluster network” (e.g., cluster communication network) when GPS signaling is unavailable; thus, groups of devices (with a selected permission code and/or signal channel designation) communicate location coordinates among themselves so one device can locate (track) another device within the group. One advantage of the “cluster network” approach (e.g., rendezvous mode as shown in FIG. 4) is that devices stay together (and track each other) without requiring access to a device network, a GPS network, or the GSM network.

Account Features

Upon obtaining access to the device network, the customer will be able to perform all of the following usage scenarios.

Log In/Log Out

Users must be able to log into their account. In one embodiment, a numeric account number and numeric password are utilized to allow an IVR to be another interface, in addition to login on a URL to access the network. Users must be able to log out. In addition, user sessions, in one embodiment, will automatically log out after a subscriber or administrator designated period of inactivity.

Create/Delete Account Wizard

Accounts are created with the “Create an Account” wizard. Users may cancel their accounts. There will be many warnings displayed, for example, to the user that the service will no longer be available. An account number, for instance, may be available in a specified time, such as six months, or another designated time.

Change Account Information

Accounts, in this exemplary embodiment, have the following properties including: account number, password, email address, mailing address, time zone, contact telephone number, secret question/secret answer, billing information, and DEFCON level.

Reassign Password

System, for instance, emails a temporary password to the user. Upon login, the system prompts for a new password.

Activate/Delete/Replace/Modify Device

Activating a new device may be performed within the “Activate Device” wizard. Users may remove a device, replace a device or add a device. Users may also modify device properties including: nickname, icon, velocity thresholds, low battery alerts (such as yes/no with email address and low battery messages, in one embodiment, may be sent to the main email account), default time zone, and DEFCON level.

Locate Devices

Individuals or groups may be located or tracked using this system. To locate or track, zones may be added, removed, modified including center point and radius. Furthermore zone type (e.g., safety or danger) and schedule (including time window) may be modified. Furthermore, notification features for a device may be modified. Notification features, in this example, include add, remove, modify, acknowledge the system upon an alert, utilize an IVR, require acknowledgement to prevent escalation, and require acknowledge receipt of a notification via the website. Notification may be temporarily suspended, suspended for a device due to unscheduled activity such as doctor appointments, holidays, sick days, etc., hibernate a device, and wakes when a device is charged or timed-out. The system also provides for devices being grouped together (e.g., “stay with the group”) so if one device strays from the group, an alert (or notification) may be sent to a group manager, such as scout master.

Create a Limited Access Account

Limited access accounts can locate a device for a limited period. In one exemplary embodiment, a limited access account user utilizes the same account number as the master account, but the user is able to assign a different password. Limited access accounts can also have nicknames (e.g. police, boy scouts, sitter, etc.), and, in one example, are provided with an expiration date. Limited access accounts may be associated with one device (in one embodiment) or several devices (in another embodiment).

In yet another example, at a subscriber's option, limited access account users may view an associated child's profile. This feature provides subscriber an opportunity to assign a limited access account to law enforcement to permit authorities, e.g., law enforcement or an agent, to view the child's profile. In addition, limited access account may be, in one or more embodiment, deleted, modified, be provided a changed nickname, password, or expiration date.

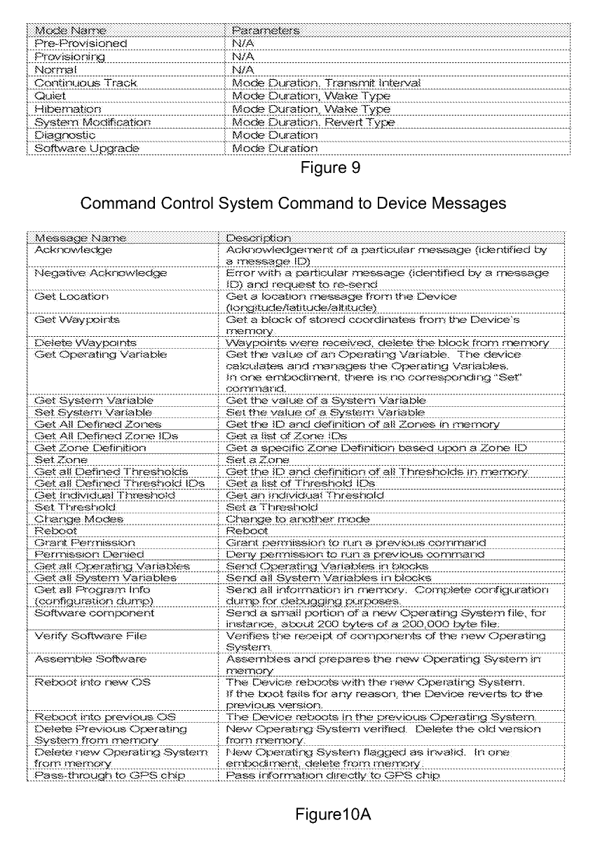

FIG. 9 is a table depicting device modes in accordance with an embodiment of the present invention. A tracking device, in this embodiment, combines a GPS chip with a GSM chip. A system administrator or network engineer for the device network programs a logic chip to operate and maintain the tracking device. The tracking device stores system variables (e.g., system-wide variable) that control it functionality. Table 1 illustrates an exemplary set of these system variables including a number of waypoints (e.g., past and present location coordinates for one or more tracking devices).

TABLE 1

| Variable | Variable Definition |
|---|---|
| Gateway1 | Name or IP address of the first Gateway server |
| Gateway2 | Name or IP address of the second Gateway server |
| Gateway3 | Name or IP address of the third Gateway server |
| Gateway4 | Name or IP address of the fourth Gateway server |
| Gateway5 | The name or IP address of the fifth Gateway server |
| Gateway6 | Name or IP address of the sixth Gateway server |
| Gateway7 | Name or IP address of the seventh Gateway server |
| Gateway8 | Name or IP address of the eighth Gateway server |
| Waypoint Maximum | Maximum number of waypoints to be stored in memory |
| Waypoint Buffer Type | 0 = circular (over-write old waypoints if the |
| | buffer is full) |
| | 1 = linear (do not store new waypoints if the |
| | buffer is full) |
| Waypoint Window Size | Maximum number of waypoints to be transmitted per |
| | message |
| Waypoint Drain Type | The way waypoints are sent |
| | 0 = Oldest waypoints first (FIFO) |
| | 1 = Newest waypoints first (LIFO) |
| Waypoint Time Interval | Time (for example in seconds) between stored |
| | waypoints. |
| | 0 = Do not store waypoints based upon a |
| | time interval |
| Waypoint Distance Interval | Distance in decimeters between Waypoints |
| | 0 = Do not store waypoints based upon a |
| | distance interval |
| Polling Interval | Time (e.g., seconds) between location |
| | messages sent to the network |
| Zone Maximum | Maximum number of zones to be stored in |
| | the device |
| Compression Option | Way message compression |
| | 0 = no compression |
| | 1 through 255 = use compression option |
| | indicated by this value |
| Encryption Option | Way message encryption |
| | 0 = no encryption |
| | 1 through 255 = use encryption option |
| | indicated by this value |
| Device Password | Password for this device |
| Serial Number | Serial number of this device |
| SIM/IMEI | Network ID of this device |
| Max Mode Duration | Period (e.g., seconds) the device will stay in |
| | modes other than pre-provisioning, provisioning, |
| | or normal |
| Max Inactive Duration | Period (e.g., seconds) before the device will |
| | enter Hibernation Mode if it does not detect |
| | vibration. If this value is 0, the device does |
| | not hibernate automatically. |
| Hibernation Duration | period (e.g., seconds) the device will hibernate |
| | if it enters hibernation mode automatically |
| Provisioning Duration | Period (e.g., seconds) the device will attempt |
| | to provision itself on the GSM network before |
| | reverting back to pre-provisioning mode |
| Communication Timeout | Period (e.g., seconds) the device will wait |
| | before assuming the device network did not |
| | receive the last message |
| | 0 = assume all message are received and |
| | take no action if there's no response. |
| | 1-65535 = Period to wait, e.g., the number |
| | of seconds, before retransmitting the message. |
| Confirmation Required | Indicates how the device will process all commands |
| | 0 = Confirmation of each command is not required |
| | 1 through 655535 = device requests confirmation |
| | commands through a different Gateway than the one who |
| | sent the message. A maximum time the device will wait |
| | for confirmation is indicated by this non-zero value. |
| | After timeout, the device will discard the message. |
| Wake Sensor | Indicates how the device will prematurely wake from |
| | Hibernation Mode |
| | 0 = Do not wake early |
| | 1 = Wake only if you detect movement from a |
| | vibration sensor |
| | 2 = Wake only if an external sensor indicates |
| | to do so (i.e. contact closure) |
| | 3 = Combination of 1 and 2 |
| GPS Margin of Error | The margin of error of local GPS fixes |

The device processes and calculates a number of local operating variables that determine its state and position. Table 2 lists and defines an exemplary list of these variables.

TABLE 2

| Operating | |
|---|---|
| Variables | Variable Definition |
| Last GPS | Time/date of the last GPS fix |
| Date Time | |
| Longitude | Last known longitude |
| Latitude | Last known latitude |
| Altitude | Last known altitude |
| Velocity | Last known velocity |
| Heading | Last known heading |
| GPS Lock Info | Information regarding satellite strength |
| | and lock info |
| GSM Lock Info | Information about current GSM connection |
| | status, tower information, and signal strength |
| Current | Current date and time |
| Date Time | |
| Last Waypoint | Date and time the last waypoint was stored in memory |
| Date Time | |
| Last LocMsg | Date and time the last location message was |
| Date Time | sent to the network |
| Last ModeChg | Date and time the device last changed modes |
| Date Time | |
| Last Vibe | Date and time the last vibration was detected |
| Date Time | (from the vibration sensor) |
| Last Software | Date and time the operating software was loaded |
| Date Time | into memory |
| Last Reboot | Date and time the device was last rebooted |
| Date Time | |
| Power Source | Indicates whether the device is on battery |
| | power or line powered |
| | 0 = Battery Power |
| | 1 = Line Power |
| Battery Level | Power level of the battery expressed as a |
| | value between 1 and 100 |
| Battery | Expected remaining battery life at current |
| Duration | usage expressed in minutes |
| Mode | Current mode |
| Waypoint Count | Number of waypoints currently in memory |
| Zone Count | Number of zones configured in memory |
| Upgrade Key | Message digest of the operating software |
| | file in standby memory |
| Software | Current software version |
| Version | |

In one example, device (a first tracking device 402 as shown in FIG. 1B) monitors signals from a Global Positioning Satellite (GPS) and transmits its position to the device network (such as system 400 shown in FIG. 1B) via a cellular or mobile network, such as Cingular's GSM network. In one embodiment, to minimize wireless network traffic (and therefore maximize battery life), the device has on-board logic for local signal processing (as shown in FIG. 5). The device includes, for example, a GPS chipset (e.g., wireless location and tracking logic circuit 810 as shown in FIG. 5) and a GSM chipset (e.g., signal transmitter 815 and signal receiver 801 as shown in FIG. 5). The microprocessor/logic circuit 810 (as shown in FIG. 5) is programmable (or preprogrammed) for one or more modes.

Pre-Provisioned Mode

Prior to shipping from a manufacturer, a device will be placed, in one embodiment, in pre-provisioned mode. In this mode, the device is not activated. The device does not attempt communication to, for example, with a cellular network (such as GSM) or a location coordinate tracking network (such as GPS). When a subscriber purchases the device and is ready to activate, the subscriber wireless connects the device to the Internet or utilizes a customer service representative (CSR) to set up an account and then places the device on a battery charger unit (such as unit 1450 shown in FIG. 14). When the device detects a charge, it enters a provisioning mode. If the device is unable to auto-provision and connect to the device network, the device will return to pre-provisioned mode. In one embodiment, the device is removed, for instance momentarily, and returned to a device power charging station to return the device to the provisioning mode.

Provisioning Mode

After the device is in a pre-provisioned mode and electrically coupled to a device charger, the device may enter a provisioning mode. The device will attempt to provision itself on the GSM network and connect to the device network. The device remains in the provisioning mode until one of the following events occur: the device successfully provisions itself on the device network and receives provisioning commands from the device network to enter a normal mode or the time parameter called “provisioning search time” is exceeded, at which time the device reverts to pre-provisioned mode.

Normal Mode

In this mode, the device will monitor its location, send appropriate events to the device network, and listen for commands from the device network. More specifically, the device in the normal mode monitors signals from the Global Positioning Satellite (GPS) network, calculates its or another device's location positional coordinates, listens for commands from the device network, and transmits the location positional coordinates to the device network, for example, via a mobile communications network, e.g., such as a GSM network.

Continuous Track Mode

The device network places a device in a continuous track mode. When placed in this mode, the device will receive, for instance, two parameters; namely, mode duration (the period that the device should stay in this mode before reverting to normal mode) and transmit interval (the period between transmitting location messages to the device network). The device will send a location message upon a period defined by a transmit interval is exceeded. All other operations continue normally. The device will remain in this mode, for instance, until any of the following events occur: a period defined by mode duration is exceeded, a period defined by max mode duration is exceeded, or a command from the device network to change modes. While in continuous track mode, the device will process commands from the device network as if it is in the normal mode, including repeat or update command.

Quiet Mode

In the quiet mode, the device will not transmit. When placed in this mode, the device, in this exemplary embodiment, receives a mode duration (the period that the device should stay in this mode before reverting to the normal mode), and wake type parameter (which indicates whether the device will send “threshold exceeded” events to the network). In addition, the device will not maintain a lock on the GSM network, but will monitor the GPS network for location information and store waypoints (e.g., intermediate or current location coordinates of the device). Furthermore, the device, in one exemplary embodiment, does not communicate messages and appears substantially invisible to the device network and one or more GSM networks.

Upon detecting a threshold violation of a subscriber policy (such as a child being outside of a designated safe zone area), the device will connect to the GSM network and send an event to the device network upon receiving an appropriate wake type parameter. In this embodiment, the device remains in this mode until a designated event occurs. The designated events may include when 1) a mode duration is exceeded; 2) a max mode duration is exceeded and the device returns to the normal mode; and 3) the device detects a threshold value has been exceeded (and the wake type is proper to transmit the event to the GSM network and transmit data to the device network).

Upon waking to detect a threshold violation, the device will transmit the appropriate message to the device network and await an acknowledgement. This acknowledgement will contain a response code to indicate the action the device should take. Response codes, for example, may include return to quiet mode for the remainder of the original mode duration parameter, or return to normal mode.

Hibernation Mode

In a hibernation mode, the device is nearly turned-off, e.g., the device is not connected to the GSM network and is not monitoring the GPS network. When placed in this mode, the device, in this exemplary embodiment, will receive two parameters: mode duration (a period that the device should stay in this mode before attempting to revert to normal mode) and wake type (which indicates how the device will wake). Examples of wake types include: 1) only when mode duration has been exceeded, 2) when placed on a base charger unit (such as shown in FIG. 14), 3) when an external sensor disposed on the device changes state (e.g., vibration sensor, moisture sensor, or the like), or 4) a combination of 1, 2, and 3 above.

In this mode, the device will simply watch its internal clock and an external sensor (if the wake type allows it). The device will revert to the normal mode if any of the following events occur: i) a period defined by the parameter mode duration is exceeded, ii.) a period defined by the system parameter max mode duration is exceeded, and iii.) if the wake type parameter is 1) or 3) and the device detects that it has been placed upon a charger, the device will connect to the GSM network and transmit data to the device network, e.g., monitoring station 506 shown in FIGS. 2A-2D, and 4. If the wake type parameter is 2 or 3 and the device detects change to an external sensor defined by the system parameter wake sensor, the device connects to the GSM network and transmits data to the device network.

If permitted to wake up in accordance with the wake type parameter, the device will transmit an appropriate message to the device network and await an acknowledgement. This acknowledgement will contain a response code to indicate the action the device should take. Two possible response codes are the device to return to quiet mode for the remainder of the original mode duration parameter and return to normal.

System Modification Mode

In the system modification mode, the device allows changes to system parameters. When placed in this mode (in this exemplary embodiment), the device will receive parameters including mode duration (a period the device should stay in this mode before attempting to revert to normal mode), and at least one of the revert types. The revert types, in this example, include types: 0 which means to revert to normal mode after receiving one single system modification command, 1 which means do not revert to normal mode after receiving system modification commands (and stay in system modification mode and expect more commands).

Furthermore, the device will revert to normal mode if any of the following events occur: a period defined by the mode duration is exceeded, or a period defined by the max mode duration is exceeded. Furthermore, if the revert type is 0, the device processes a system modification command. The device continues to operate, e.g., transmitting messages, processing commands, and receiving information and data, while in system modification mode.

Diagnostics Mode

Diagnostics mode allows troubleshooting and debugging a device. In this exemplary embodiment, when a device is placed in this mode, the device receives two parameters including a mode duration and transmit interval. The mode duration is a period that the device stays in the mode before attempting back to the normal mode. The transmit interval is a period between transmitting debug messages. If this parameter is zero, then no regular debug message is sent.

During this mode, the device will receive a command from the network to revert to the normal mode if any of the following occur: i.) a period defined by the mode duration is exceeded or ii) a period defined by the max mode duration is exceeded. Diagnostics mode appears as a “verbose system modification mode” in that the device will allow changes to system parameters, but it will send information regarding internal memory, command processing, network strength and the like. In addition, the device will transmit a debug message after the number of seconds defined by a transmit interval parameter.

Software Modification Mode

The software modification mode is a special mode that allows the internal program to be upgraded or downgraded. Because this mode affects operation of the device, a key command is transmitted. To allow software modification, the key command, in this embodiment, needs to match the key system parameter, e.g., upgrade or downgrade type. When placed in this mode, the device will receive two parameters: mode duration (which is a period the device stays in this mode before attempting to revert to the normal mode) and key (the upgrade key, which matches the upgrade key operating variable).

Small sections of new operating programs are sent to the device while it is in normal mode, where they are stored in memory. When the entire program is received, the device assembles the file and calculates a message digest. This digest is stored as the upgrade key operating variable. When the device enters the software upgrade mode, it verifies that the parameter key matches the operating variable upgrade key. If the keys do not match, the device reboots and attempts to start the new program. If device cannot establish connection to the device network after a period defined by the provisioning search time, the device reverts to the old program.

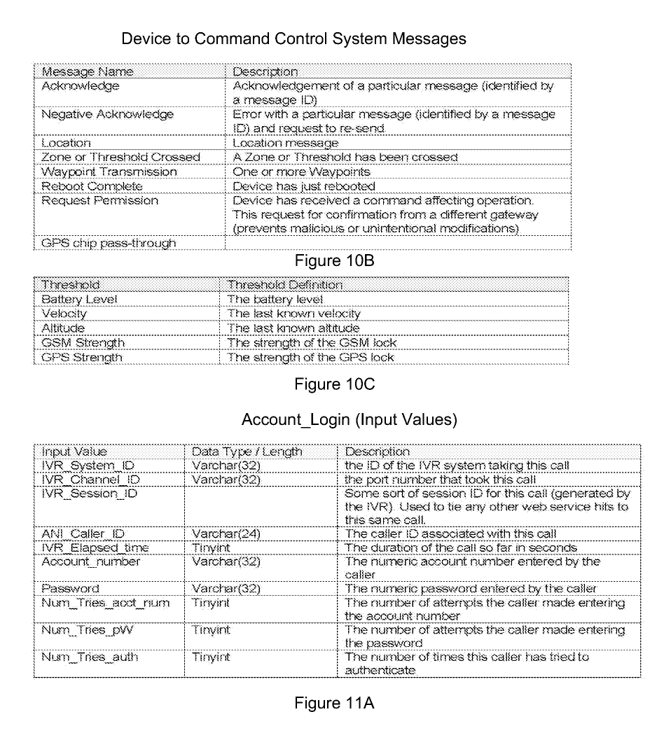

FIGS. 10A-10C are tables of messages communicated in accordance with an embodiment of the present invention. This section describes the messages that are sent by the command and control system (e.g., a monitoring station 506 such as shown in FIGS. 2A-2D) and messages sent by the device to the command and control system. In one embodiment, the device network communicates management commands to perform a modification to the operational programming of a device (e.g., a first or second tracking device 402, 410 as shown in FIG. 5). After a connection is established between the device (such as the first tracking device 402 or the second tracking device 410), device events are communicated to the device network (such as database 577 shown in FIG. 2D). Events are communicated in response to the device having a change of state or location, e.g., new positional coordinates. Events are processed by the device network and may generate alerts or notifications.

Exemplary command and control system messages initiated by the device network (described in more detail in FIG. 10A) include getting waypoints, system variables, operating variables, assembling software, and obtaining operating system.

Exemplary device messages (initiated by the device) include in generally device change of state, change in position, or a scheduled event is, will or has occurred. These device messages are processed by the command and control system and may generate additional messages or activity on the device network. These device messages (described in more detail in FIG. 10B) include acknowledge of messages, location, zone or threshold crossed, waypoint transmission, reboot device, request permission, and GPS chip pass-through. Also, the command and control system monitors, for example, a threshold as shown in FIG. 10C.

Zones

The device is continuously monitoring its position in relation to zones defined by the subscriber. The device stores zones in memory so it does not need to continuously transmit its location to the device network. When the device detects, it sends an event to the device network for the command and control system to process. Conventional GPS networks introduce errors when calculating location coordinates of objects or individuals due to, for example, when the object or individual is traveling at a high velocity or when the object or individual is out of range of the GPS network, e.g., when inside a building or has a partially or fully obstructed view from the GPS network. In contrast to convention GPS networks, the command and control system allows a margin of error to exist around a perimeter of the zones (such as an error quantity (described in Zone Definition below) providing an error margin about a zone perimeter (such as circle 421) depicted in FIG. 1A to prevent false alerts.

Zone Definition

Zones, in this exemplary embodiment, are substantially circular in nature (but the zones may include other shapes, including arbitrary shaped zones). A center point and a radius define the substantially circular zones. The command and control system communicates zones to the device. In this embodiment, the zone is not modified by the device. Furthermore, the device is programmed to calculate coordinates with a margin of error. The margin of error is defined by the following variables:

e=margin of error,

(h, k)=center point of the zone

r=radius of the zone.

During a check of the device relative to the zone, the device will calculate a location position value relative to each zone. The position value calculation is represented by:
P=(rc−ri)/2*e
P=positional coordinates
rc=radius of zone from the center point
ri=radius of location coordinate from the center point
e=margin of error (e.g., set by the subscriber, the device network, administrator, etc.)

In this exemplary embodiment, if P is less than 0, the device is within the zone. If P is greater than 1, the device is outside the zone. A value of P between 0 and 1 will give the device's positional coordinates (linear) within a designated margin of error. In contrast to conventional systems, the present invention incorporates a designed margin of error to reduce a number of events (due to a minimal deviation of a child from a designed zone such as when child is playing along a perimeter of a zone, e.g., such as a safe zone or, in yet another embodiment, a danger zone).

Thresholds

The device is capable of monitoring certain operating variables and determining if these variables are maintained within threshold values. If the values fall outside the acceptable range, the device will send an event to the device network. The command and control system processes the events.

Device System Variables

The device stores a number of system-wide variables that control how it functions. These variables are rarely modified, and if they are, they are sent by the device network and are not calculated by the device.

Device Operating Variables

The device network processes and calculates a number of local operating variables that determine its current state and position. These Operating Variables are calculated by the device. Unlike System Variables, the device is able to change Operating Variables.

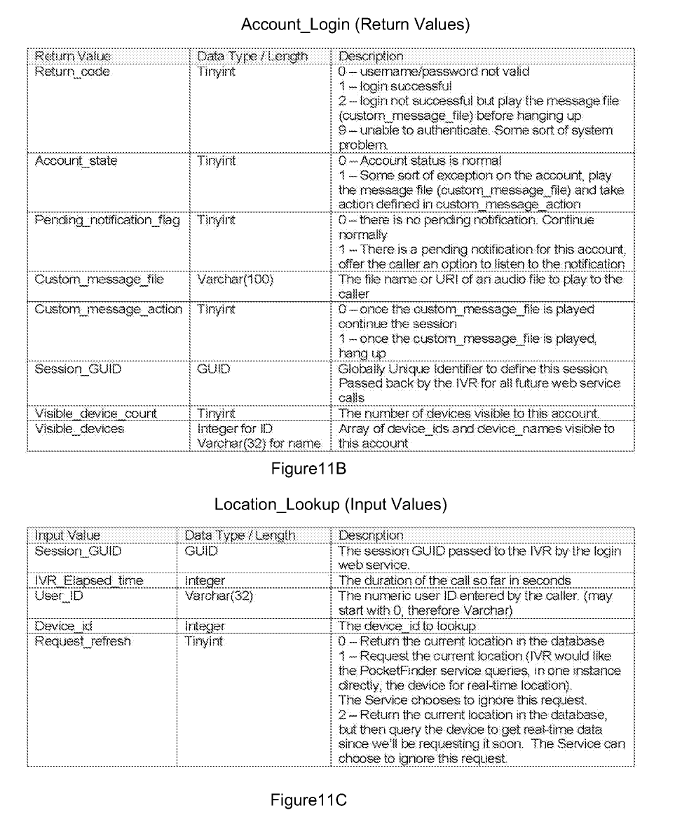

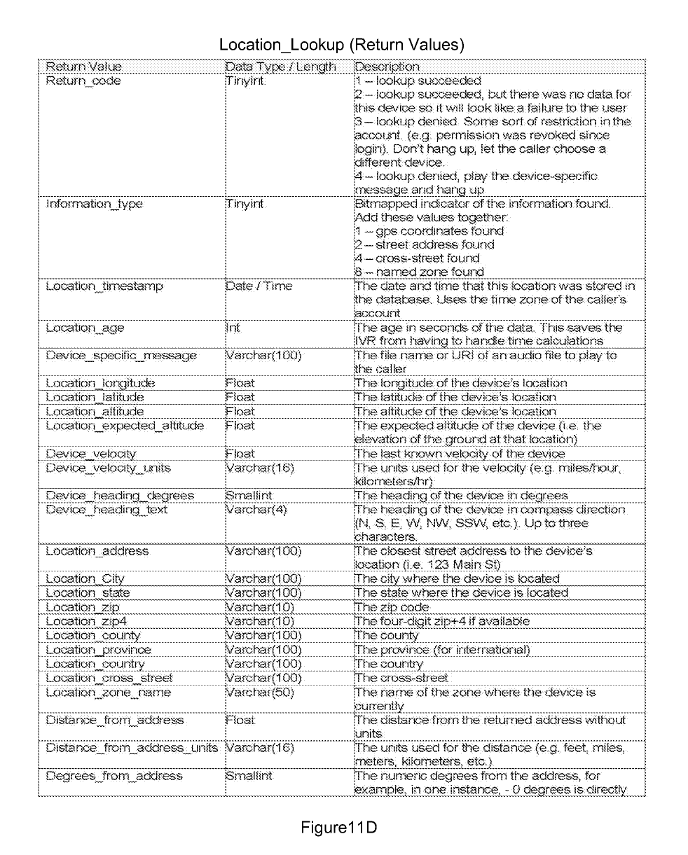

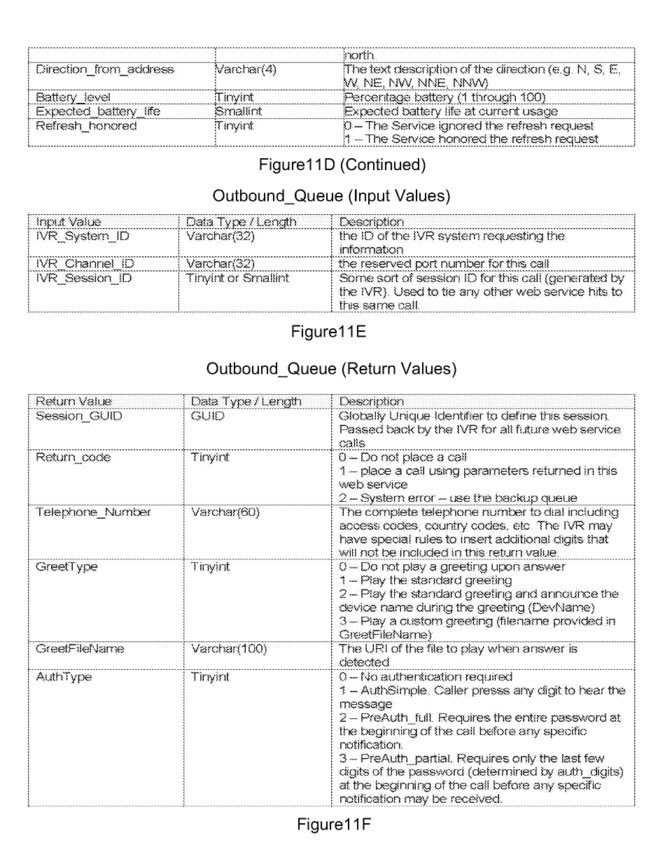

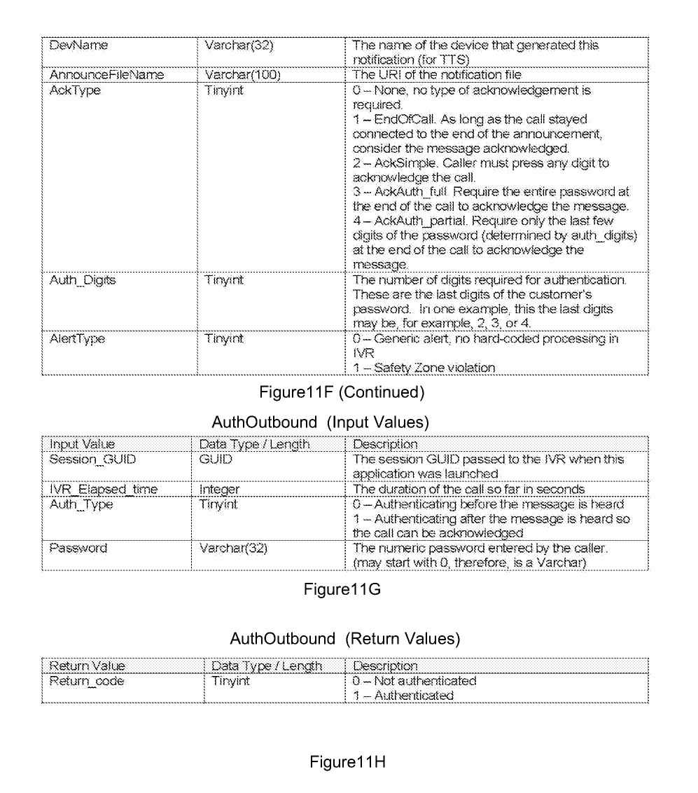

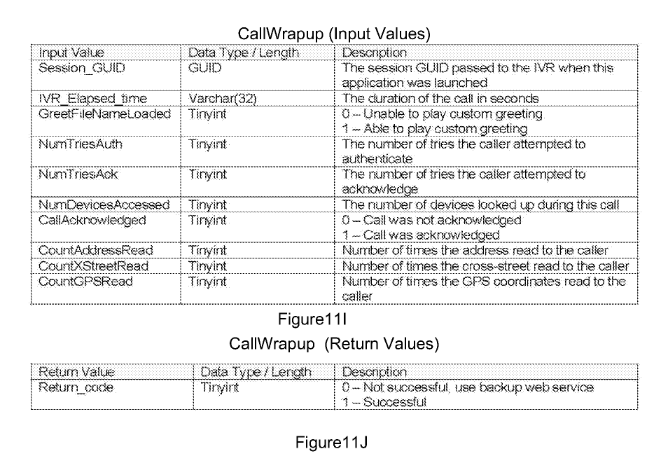

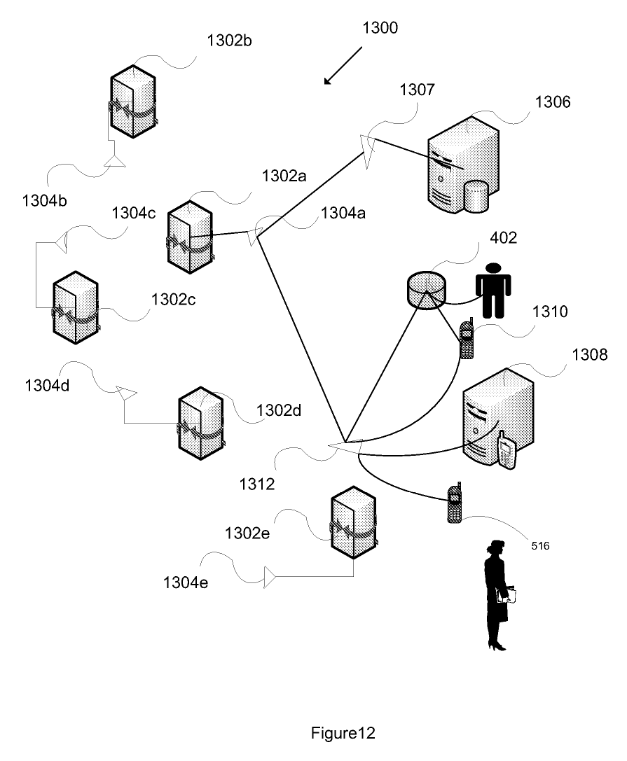

FIGS. 11A-11J are tables illustrating commands for web services in accordance with an embodiment of the present invention. The web services define interface variables and protocols utilized for communication between components of the network (and are further defined in the FIGS. 11A-11J). Below are summaries of general functionality of a set of exemplary web services.

Login

When dialing into the VoiceXML application (e.g., IVR Login Web Service), a caller enters a user identification code, e.g., an account number, and a password, e.g., number or letters or a combination thereof, through the login web service. The login web interface authenticates the caller. The device returns, in one example, a response code, information about a pending message for the caller (e.g., trying to notify you regarding event XXX), and a list of devices that are or will be responding to the caller.

Location_Lookup

When a caller selects a device, an IVR application, for instance, calls an IVR_Location_Lookup Web Service to get location information for the device. One feature, in this embodiment, includes a direct query flag. The direct query flag, in this interface, caches information or queries the device directly (e.g., if the cached value is too old). The Location_Lookup Web Service, in one example, determines if the “direct query” flag is still valid.

Outbound_Queue

When the network needs to notify a subscriber via a telephone, IVR may be utilized to contact a subscriber and play a message. In one exemplary embodiment, an IVR_Outbound_Queue web service returns information about the next outbound call. The IVR calls the IVR_Outbound_Queue web service to determine if any queued calls exist and returns information to place the call. Because notifications are a part of the web services, in this example, there will be two separate queues, e.g., if connections fail to the first queue, the IVR will attempt to connect to a backup queue.

Auth_Outbound

This web service authenticates an identity of an individual called by the IVR from a notification prompt. In certain cases, the individual called must authenticate to listen to a message.

Call_Wrapup

This web service operates after incoming and outgoing calls. It gives the IVR an opportunity to log call activity during the session.

FIG. 12 is a graphical representation of gatekeeper interface in accordance with an embodiment of the present invention. Gatekeepers 1302a-e are, in one embodiment, stateless, and store no information (including data). In yet another example, gatekeepers may store information (at least temporarily). The gatekeepers (such as 1302a-e, which a.k.a., gateways) provide an interface between the device network component 1306 (e.g., a storage server such as the database 557 in FIGS. 2A-2D) and the device 402 (also shown in FIG. 5). In this embodiment, Gatekeeper 1302a communicates between the GSM network 1308 and the device network component 1306 through telecommunications connect protocol/internet protocol (TCP/IP). In one variant of this embodiment, the device 402 downloads its location coordinates to mobile phone 1310 (which communicates the information to antenna 1312 to the GSM network 1308. For instance, in an emergency situation, a child having the tracking device 402 may download location coordinates (e.g., last available) to the mobile phone 1310. Afterwards, in one embodiment, the mobile phone 1310 passes the location coordinates through the GSM network 1308, which transports the location coordinates through the gateway 1302a for transport to the device network component 1306 (having data storage capability).

In one embodiment, an operator (such as emergency or 911) or subscriber or other representative may access the location coordinates stored in the device network 1306 after receiving a message (such as an emergency message or alert) from the mobile phone 1310, in this embodiment, associated with a child. Furthermore, more than one gatekeeper, such as 1302a-e, is available for every device, so as the device passes through the device network, it should have capability to connect to at least one gatekeeper. In yet another embodiment, if there are more gateways than necessary to handle communication traffic load, gatekeepers 1302a-e may be removed from the network with negligible effect on the device 402 stability or functionality.

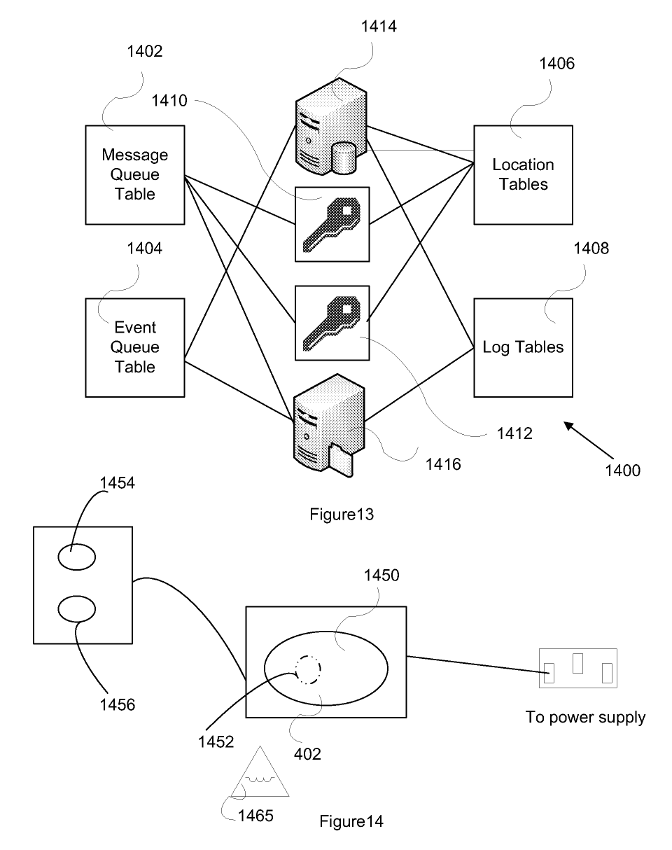

FIG. 13 is a graphical representation of a data management system in accordance with an embodiment of the present invention. The database management system 1400 is split among several individual databases and servers. In addition, the several individual databases and servers are networked using clustering and RAID options. In this embodiment, the database management 1400 system includes the message queue table 1402, event queue table 1404, location tables 1406, and log tables 1408 logically connected among several individual databases 1410, 1412 and servers 1414, 1416 using various clustering and RAID options (to provide information redundancy).

Message Queue Table (1402)

The message queue table, in one example, includes messages from the command and control system to the devices, and messages from the device to the command and control system. Messages from the command and control systems are placed in the queue, picked up by the gatekeeper, and passed to an intended device. Messages from the device are received by the gatekeeper, placed in the message queue table, and processed by the command and control system.

Event Queue Table (1404)

The event queue table contains events raised by the device. These events are processed by the command and control system.

Location Tables (1406)

A function of the device network is monitoring a location of the device. The location tables include, for example, current location, breadcrumb, and location history. In one example, the current location table stores a current location of the device. In one example, there is one record per device in the table containing the most recent reported location. When a new location is added to the current location table, the existing location is written to the breadcrumb table. The command and control system “inspects” records written to this table.

The breadcrumb table provides one or more recent location for each device. The breadcrumb table is updated as a record written to the current location table. The breadcrumb table is populated with waypoint data from the device. These waypoints, in one embodiment, do not pass through the current location table. The command and control system inspects records written to the breadcrumb table to ensure records are inspected. After some configurable amount of time, records are moved from the breadcrumb table to the location history table.

The location history table includes long-term storage for all device locations. Records are moved here from the breadcrumb table and are stored for a duration defined by, for example, a subscriber's data retention policy. In one embodiment, records are (when no longer needed) periodically deleted.

System Log Tables (1408)

The system log tables contain information the network and, in one embodiment, logs and enters these events in tables.

Command and Control System

The command and control system, e.g., the monitoring system 506, is the “brain” of the device network. It monitors activities and events of one or more devices and acts, in one embodiment, in accordance with a set of business rules. The command and control system includes many subsystems: device management, zone management, threshold management, event management, alert management, and notification management.

Device Management

The command and control system stores configuration of devices in the device management database. Location management functions, in one example, are delegated to the device (to minimize network traffic). To ensure accuracy, the command and control system, in one embodiment, initiates periodic configuration audits while a device is charging.

Zone Management

The command and control system checks location information and waypoint information received from a device against that in the zone management system. In one example, customer designated zones are substantially circular (and may be concentric) in nature. Some zones may be designated as safety zones (e.g., where the tracking device is recommended to remain) and some as danger zones (e.g., where entry is not recommended). If a device's location violates a zone, an alert is triggered.

Threshold Management

The command and control system monitors a device for violations of defined thresholds. Examples of thresholds are device velocity, battery level, and data from sensors that monitor parameters such as temperature, shock, moisture, etc. In one embodiment, to conserve battery level, the command and control system may poll a device for location information at various discrete (aperiodic time intervals) so that if a device does not check-in its location, the system does not require the device to continue requesting GPS coordinates (if the satellite is out-of-range) or the GSM system is unavailable. In contrast to conventional tracking devices, the command and control system (and or the device of the present invention) does not continue to attempt contacting a GPS satellite or GSM system (when unavailable) and cause a device to drain its battery power. In another embodiment of the present embodiment, aperiodic check times for the device conserve battery power as compared to those conventional tracking systems having periodic device check-in schedules.

Event Management

The devices monitor events on the device network. The command and control system acts on these events, in one embodiment, accordance with subscriber and administrator designated programming, scripts, procedures and business rules. Some of these events, for example, may result in an alert sent to a subscriber, a person on a notification list, a limited access account user, or directly to a tracking device.

Alert Management

Generally, the command and control system handles events from the device. Examples of the events include “device placed on battery charger”, “battery fully charged”, or “device entered a safety zone”. However, the device may raise events that may trigger an alert such as “battery low” or “exited a safety zone”. If the event violates a rule or a threshold set by, for example, a subscriber or administrator, then the event may trigger an alert. The command and control system will write a record to the notification queue.

Notification Management

The notification queue contains notifications for later processing. In one embodiment, notifications are communicated via telephone call to the customer (or other on a list (e.g., notification list 408). In yet another embodiment, notifications are sent by email.

FIG. 14 depicts a schematic of a battery charger unit for a device in accordance with an embodiment of the present invention. In this embodiment, a battery charger unit 1450 has no direct electrical connection, e.g., an inductive charger, supplies electrical power to the device (such as the first tracking device 402). The battery charger unit 1450, e.g., a power charger pad, inductively couples magnetic energy to the device 402. In particular, the power charger pad has an inductive charging system that magnetically couples AC power from a primary inductive coil (not shown in the FIG. 14) disposed within the base charger unit 1450, to a secondary inductive coil (not shown in the FIG. 14) disposed in the device 402.

Current flows through the primary inductive coil, inducing magnetic flux on the secondary inductive coil, and producing an alternating current through the magnetic field and across the secondary inductive to complete a charging circuit. The AC current converts to DC (using a standard dc coupling transformer) for storage in an internal battery 1452. One major advantage of inductive charging approach is no metal-to-metal contact is required between the charger unit (e.g., the battery charger unit 1450) and an internal battery (e.g., battery 1452) of the device. The device 402 on the battery charger unit 1450 replenishes its internal battery 1452. In this example, charging is complete when an red indictor light 1454 turns-off and a green indicator light 1456 turns-on and the device 402 sends a charged status signal to the device network (such as system 400 shown in FIG. 1B) and a parent and a device manager (a subscriber, a user, or the like) may be notified.

Other alternative embodiments are available for charging a battery of a device. For instance, a device 402 deployed substantially outdoors charges using solar energy (e.g., sunlight). In this example, the device may include at least one solar cell (not shown) (e.g., in place of or in addition to the internal battery 1452), e.g., disposed directly on the device or under a translucent plastic cover, e.g., a film of clear or semi-transparent hybrid plastic material portion. The device, in one alternative embodiment, may have another or substantial portion that is substantially opaque in nature produced of polycarbonate abs plastic that, in one embodiment, may be substantially a one-piece, and substantially environmentally sealed (e.g., hermetic) and, in one embodiment, including no exposed metal connectors or contact points. In this same embodiment, sunlight (or ultra-violet light) strikes the at least one solar cell to charge the device 402.

In yet another alternative, a magnetic coil (such as coil 1465) mounted near a device 402 may induce magnetic charge on an internal device battery (such as internal battery 1452) using Faraday's induction principles, which magnetic charge principles are well-known among those skilled in the art at the time of the present invention. In yet another example, a device 402 may have built-in inductive charging capability that charges the device 402, for a limited period. For instance, if a child shakes a device 402, storage energy may develop in the device 402 using similar principles to inductive charging flashlights (not shown) that when shaked cause a voltage to store across a battery, such as internal device battery 1452. In one variation of this inductive charging embodiment, a device (such as the tracking device 402) moves with a child, a pet, or vehicle, device vibration (e.g., shaking), such as when an abducted child is transported in an automobile traveling at a high rate of speed (e.g., 50 mph). The device vibration, if both frequent and powerful enough, is capable of creating at least a trickle current to partially charge an internal battery (e.g., the internal battery 1425) of a device 402. In an alternative embodiment, a tracking device (such as 402) utilized in a vehicle with an accessible power charging plug (such as that shown in FIG. 8) may obtain hard-wired power.

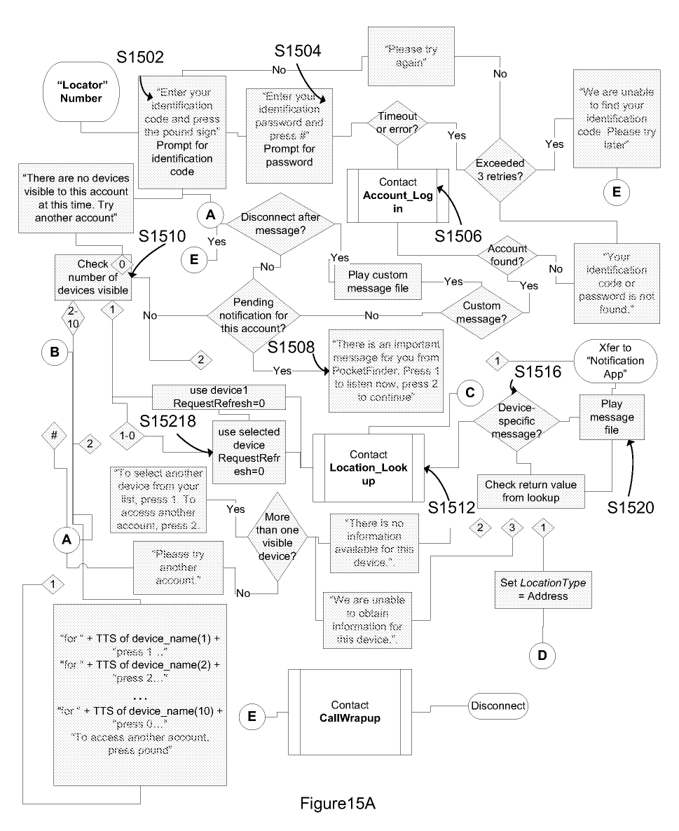

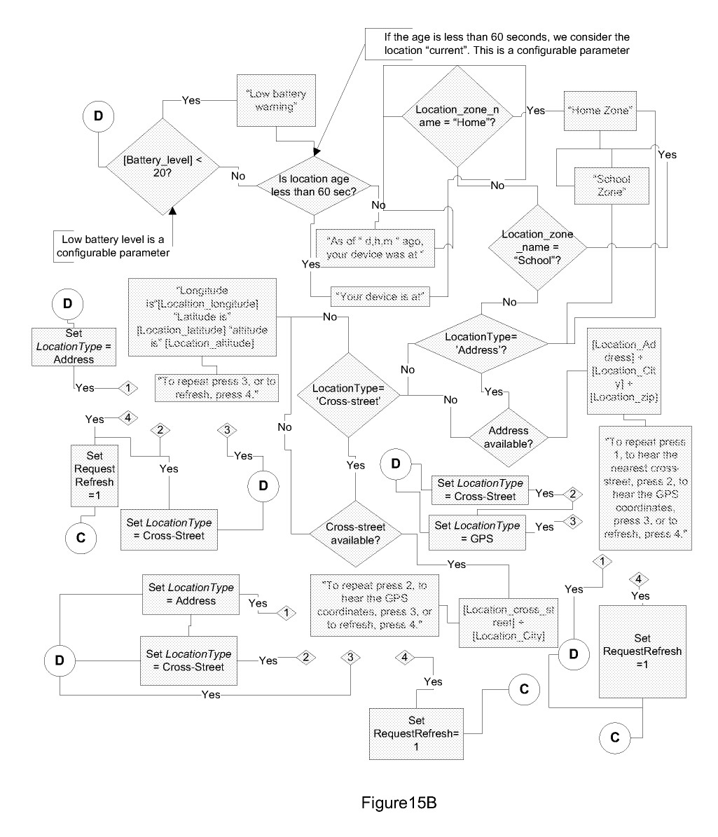

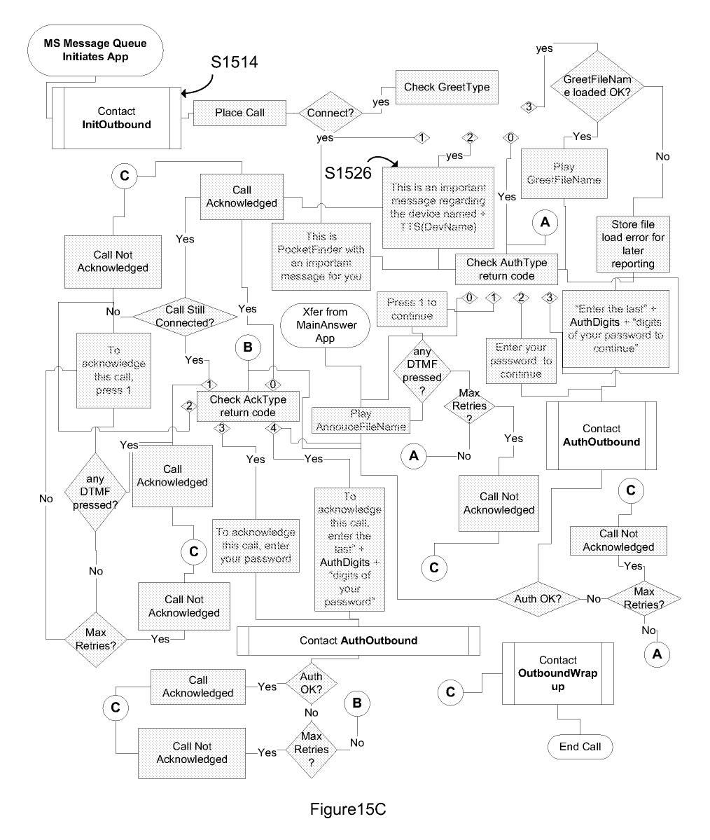

FIGS. 15A-C are logical flow diagrams illustrating an exemplary embodiment of the system in accordance with an embodiment of the present invention.

In one example, a user enters user's identification code and user's password (S1502, S1504). Upon successful completion (no timeout error, no exceed number of tries), contact (e.g., call, access, or the like) Account_Login (S1506). Determine if any messages exist for the user or pending notification for this account (S1508). Determine if any devices are visible (S1510). Contact Location_Lookup (S1512). Contact InitOutbound to determine if there is a message (S1514). Determine if information is available for any devices (S1516). Set device location type (S1518). Play message for a specific device if available (S1520).

It is noted that many variations of the methods described above may be utilized consistent with the present invention. Specifically, certain steps are optional and may be performed or deleted as desired. Similarly, other steps (such as additional data sampling, processing, filtration, calibration, or mathematical analysis for example) may be added to the foregoing embodiments (e.g., as shown in FIGS. 15A-C). Additionally, the order of performance of certain steps may be permuted, or performed in parallel (or series) if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions and changes in the form and details of the device or process illustrated may be made by those skilled in the art without departing from the spirit of the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A system comprising:
a first tracking device comprising a first transceiver;
a monitoring station to track location information of the first tracking device;
a user interface to remotely access the monitoring station, the user interface comprises:
i.) a graphical rendering of a keypad that comprises both numeric and letter designations; and
ii.) a tool useful to select a series of keystrokes on the graphical rendering of a keypad that substantially prevents unauthorized communication of the series of keystrokes;
wherein upon successful completion of a secure login process associated with the user interface, a first request signal is communicated to obtain location coordinates of a first tracking device;
wherein the first tracking device transmits a first reply signal that comprises a first identification code; and
wherein a second tracking device having a second transceiver to receive the first reply signal, compares the first identification code to a stored identification code, and communicates to the monitoring station a second reply signal that comprises the location coordinates of the first tracking device in part responsive to verification of the first identification code.

2. The system of claim 1, wherein the location coordinates of the first tracking device are determined at least in part from second location coordinates of the second tracking device and a distance between the first tracking device and the second tracking device.

3. The system of claim 1, further comprising a first mobile transceiver that receives first mobile station location coordinates, receives second location coordinates of the second tracking device;
wherein the location coordinates of the first tracking device are calculated by at least:
(i) determining a distance between the first tracking device and the second tracking device; and
(ii) calculating the location coordinates of the first tracking device based at least in part on the distance and the first mobile station location coordinates.

4. The system of claim 1, further comprising a first mobile transceiver and a second mobile transceiver;
wherein the first mobile transceiver and the second mobile transceiver receive first location coordinates and second location coordinates respectively; determine a respective distance from the first tracking device; and communicate each of the respective distances to the first tracking device; and
wherein the first tracking device calculates location coordinates based at least in part on the respective distances and the first and the second location coordinates, and communicates the location coordinates to the second tracking device.

5. A system comprising:
a first tracking device having a first transceiver configured to receive a first request signal in response to successful completion of a secure login process on a keyboard rendering on a remote user terminal that is substantially untraceable by keystroke recording software, and to transmit a first reply signal that comprises a first identification code; and
a second tracking device having a second transceiver that is configured to:
(i) receive the first reply signal;
(ii) compare the first identification code to a stored identification code;
(iii) determine location coordinates of the first tracking device; and
(iv) communicate a second reply signal that comprises the location coordinates to a monitoring station connected to the user terminal in part responsive to verification of the first identification code.

6. A system comprising:
a non-secure user interface to provide selective sharing of location information between users of an Internet accessible information database, the non-secure user interface to provide a graphical rendering of a keypad having keys that respond to numeric or letter entries and a tool configured to enter a user's identification code and a user's password on the keys of the keypad;
wherein the graphical rendering of the keypad and the tool substantially prevent entry of the user's identification code and the user's password being recorded without permission;
a first tracking device having a first transceiver to receive a first request signal and to transmit a first reply signal that comprises first location data in response to successful entry of the user's identification code and the user's password;
a first microprocessor to process a first request signal provided through the user interface, and a first identification code communicated as part of a first reply signal; and
a second tracking device having a second tracking transceiver to receive the first reply signal, and verify the first identification code as a recognized code, and in response communicate a second reply signal that comprises a second identification code to the first tracking device;
wherein the first tracking device calculates, in response to the second reply signal, a distance between the first and the second devices, and communicates an adjustment signal that comprises at least one of verbal and audio queues that indicates directional information of the first tracking device relative to the second tracking device.

7. The system of claim 6, further comprising a monitoring station that is remotely accessible through a secure user interface;
wherein the secure user interface provides a map and a screen pointer tool for selecting an arbitrary shaped zone on the map, and communicates the first request for location coordinates of the first tracking device; and
wherein the secure user interface is a web-based interface that provides a selection of at least one of (i) known safe street addresses, (ii) safe zipcodes, and (iii) safe distances between the first tracking device and a designated safe location.

8. The system of claim 6, wherein the secure user interface further comprises a notification function that is configured to generate an alert upon the first tracking device being detected outside a safe zone.

9. The system of claim 7, wherein the map is configured to display selected tracking devices that are located a specified distance from a first tracking device; and upon appropriate security permissions, provide the user capability to utilize the selected tracking devices to assist determining the location coordinates of the first tracking device.

10. The system of claim 7, wherein the map is configured to display other tracking devices that are a user-defined distance from the first tracking device; and upon appropriate security permissions, provide the user capability to utilize the other tracking devices to determine in part the location coordinates of the first tracking device.

11. A method comprising:
providing a first mobile transceiver station to communicate between a first tracking device and a monitoring station;
providing a second mobile transceiver station to communicate between the first tracking device and the monitoring station;
providing a non-secure user interface to remotely access the monitoring station, the non-secure user interface having a graphical rendering of an input device that substantially prevents unauthorized recording of a user's identification code and a user's password during a login process from a non-secure user terminal;
selectively sharing account information of an Internet information database in response to successful completion of the login process with the authorized user;
providing a map and a designation tool to the authorized user to use in selecting a zone on the map;
communicating a first request by the authorized user for position coordinates of the first tracking device;
receiving the first request signal by the first tracking device; and
transmitting a first reply signal that comprises a first identification code in response to the first request signal;
wherein the first tracking device is adapted to receive a second identification code from the monitoring station and compares this code to a stored identification code, and
upon determining that the second identification code matches the stored identification code, transmit its position coordinates to the monitoring station.

12. The method of claim 11, further comprising the steps of:
monitoring with low signal detection circuitry received signal strength of a positioning signal;
switching by the first tracking device to a wireless location and tracking mode upon the low signal detection circuitry determining that the received signal strength is above a defined level;
receiving the position signaling coordinates; and
storing the positioning signal coordinates as its position coordinates.

13. The method of claim 11, further comprising the step of:
upon a user request, determining the position coordinates utilizing at least two of the following position calculation modes: positioning satellites, tracking device to tracking device, and a mobile transceiver system.

14. A method for locating a tracking device, comprising:
entering on a non-secure user webpage a user identification and a user's password to access an location coordinate Internet database in a remote monitoring station that is securely selectively shared among authorized users; wherein the user identification and the user's password are substantially prevented from being recorded by unauthorized devices or software during an entry process on a keypad;
retrieving a user's identification code from the location coordinate Internet database upon successful entry of the user identification and the user's password;
activating the tracking device;
receiving a signal sent from the remote monitoring station to the tracking device, the signal including the user's identification code;
recognizing the user's identification code as a location request pertaining to the tracking device;
requesting positioning coordinates;
formatting a response to the location request including the positioning coordinates, the response including location data pertaining to the tracking device in part response to a level of the signal;
transmitting the response to a server; and
rendering the tracking device location within a map that contains a user-defined arbitrary shaped safe zone on a secure user webpage capable of remotely accessing the location coordinate Internet database.

15. The method of claim 14, further comprising:
upon determining that the received signal strength being below the defined value, a first mobile station signal and a second mobile station signal that comprise respective positional coordinates are communicated to the tracking device; and
determining a positional location of the tracking device utilizing the respective positional coordinates.

16. A method of determining location via a tracking device associated with an individual or an object to be located, the method comprising:
receiving a location request from a user in response to successful entry of a login identification code and password during a login process on a non-secure webpage;
wherein during the login process, the login identification code and password are substantially secured from being recorded by unauthorized recording devices;
activating a positioning apparatus associated with the tracking device;
transmitting to the tracking device:
a first signal from a monitoring station;
a second signal from a wireless location and tracking system;
a third signal from a mobile transceiver; and
a fourth signal from an adjacent tracking device;
determining which of the first signal, the second signal, the third signal, and the fourth signal match defined selection criteria stored in the tracking device;
determining location data in part based on a signal selected utilizing the defined selection criteria;
transmitting the location data to the monitoring station for analysis to determine a location of the tracking device; and
informing the user of the location of the tracking device on a map.

17. The method for locating an individual or an object of claim 16, wherein the signal transmitted from the monitoring station to the tracking device includes a user's identification code.

18. The method for locating an individual or an object of claim 16, wherein the tracking device comprises;
a composite plastic material that is substantially sealed about the tracking device to protect electronics and circuit boards within the tracking device from performance degradation in response to exposure to environmental conditions;
a signal receiver to receive the signal from the monitoring station to the tracking device, including a user's identification code;
a microprocessor/logic circuit to store an identification code to utilize as a stored identification code, to determine a location of the tracking device, and to generate a positioning signal;
a programmable memory;
a wireless location and tracking system logic circuit; and
a signal transmitter.

19. The method of claim 17, wherein the tracking device compares the user's identification code to a stored identification code and upon determining that the user's identification code matches the stored identification code, a signal transmitter from the tracking device transmits a positioning signal to the monitoring station.

20. The method of claim 16, further comprising:
calculating speed of the tracking device;
providing a warning signal to at least one of the user, a subscriber of this method, the individual, or the object when movement of the tracking device exceeds a designated value.

21. The method of claim 16, further comprising the step of:
communicating at least one of a verbal or electronic signaling warning when the tracking device is detected more than a designated distance from a designated coordinate position.

22. A system comprising:
a remote located monitoring station;
a non-secure wireless monitoring device associated with a remote user is capable of utilizing a non-secure user interface or a secure user interface to access the remote located monitoring station upon successful completion of a login process, the login process comprising entry of a user's identification code and a user's password on a keypad;
wherein the keypad has keys comprising both numeric and letter designations on at least one of the keys and the entry of the user's identification code and the user's password are substantially prevented from being recorded without permission in a memory location or by unauthorized software routines;
a first tracking device comprising a substantially opaque composite plastic outer shell that is substantially sealed from environmental conditions and has not exposed contacts or connectors; wherein the first tracking device is capable of being remotely programmed and providing a wireless positioning signal to a monitoring station; and
a mapping apparatus provided as part of a secure web page that maps first location coordinates of the first tracking device on a map comprising an arbitrarily shaped safe zone;
wherein the remote user is capable of locating, tracking, and communicating with the first tracking device through a monitoring station; and
wherein the monitoring station is adapted to monitor the first location coordinates and second location coordinates of a second tracking device so that positioning information of each is accessible to the remote user.

23. The system of claim 22, wherein the wireless monitoring device comprises a cellular phone that accesses remote user selectable maps in response to the first location coordinates and the second location coordinates.

24. The system of claim 23, further comprising user selection criteria configured to allow a subscriber, remote user, or a user to choose a method of determining location coordinates, the user selection criteria selected based on performance characteristics of the system; and
wherein the system is selected from the group consisting of: a wireless locating and tracking system, and a wireless communication system.

25. A device monitoring system comprising:
a group of tracking devices receiving permission to utilize at least one other tracking device of the group of tracking devices for a specified time period to coordinate velocity and location coordinate information when at least one of the group of tracking devices is out of a line of site of a GPS tracking system;
location tables to store values of past and present location coordinates of the group of tracking devices;
a message queue to store messages to pass among members of the group of tracking devices; and
a zone management system to designate zones as safe zones or danger zones and to alert members of the group of tracking devices by email, phone, or text message if one of the group of tracking devices enters by more than an designated error margin at least one of the danger zones for a substantial period.

26. The system of claim 25, wherein at least one of the group of tracking devices comprises a composite plastic abs material that is a substantially sealed, one piece unit and resistant to device performance functionality variations in response to at least one of water exposure, extreme cold temperature exposure, or hot temperature exposure.
